(19) United States
(12) Patent Application Publication
(10) Pub. No.: US 2009/0234671 A1
(43) Pub. Date: Sep. 17, 2009

(54) PATHOLOGY LAB MANAGEMENT SYSTEM AND METHOD

(76) Inventors: Jason D. Jones, Ocala, FL (US); Scott C. Reynolds, Ocala, FL (US); Brian Pina, Ocala, FL (US); Rushunda Gordon, Ocala, FL (US)

Correspondence Address: W. EDWARD RAMAGE, COMMERCE CENTER SUITE 1000, 211 COMMERCE ST, NASHVILLE, TN, 37201, US

(21) Appl. No.: 12/268,421

(22) Filed: Nov. 10, 2008

Related U.S. Application Data
(60) Provisional application No. 60/986,454, filed on Nov. 8, 2007.
(60) Provisional application No. 61/112,217, filed on Nov. 7, 2008.

(51) Int. Cl. G06Q 50/00; G06F 17/30; G06Q 10/00; G06Q 30/00; G02B 21/34

(52) U.S. Cl. 705/2; 707/10; 705/34; 436/174; 707/104.1; 707/E17.019; 707/E17.044

(57) ABSTRACT

A system and related methods for receiving, processing, managing, reviewing, analyzing, evaluating, and reporting information about pathology specimens and specimen handling. A system in accordance with the present invention provides a functional data environment for receiving and processing incoming specimens, collecting patent information and entering it into the system, preparing individual specimens, embedding specimen-bearing cassettes in paraffin wax, cutting the specimen into thin sheets and mounting them on slides, slide preparation, assigning and dispatching a prepared case to a pathologist for diagnosis, issuing a diagnosis, collaborative review of problem cases, performing maintenance for case data, and issuing reports.

This application claims priority to Provisional Patent Application No. 60/986,454, filed Nov. 8, 2007, and Provisional Patent Application No. 61/112,217, filed Nov. 7, 2008, both entitled “Pathology Lab Management System and Method,” and is entitled to those filing dates for priority. The complete disclosure, specification, drawings and attachments of Provisional Patent Application Nos. 60/986,454 and 61/112,217 are incorporated herein in their entireties by reference.

### FIELD OF INVENTION

This invention relates to a system and method for the processing, evaluation, and reporting of information and material within a pathology laboratory environment.

### SUMMARY OF INVENTION

In one exemplary embodiment, the present invention comprises a system and related methods for receiving, processing, managing, reviewing, analyzing, evaluating, and reporting information about pathology specimens and specimen handling. A pathology management system in accordance with the present invention provides a functional data environment for receiving and processing incoming specimens, collecting patent information and entering it into the system, preparing individual specimens, embedding specimen-bearing cassettes in paraffin wax, cutting the specimen into thin sheets and mounting them on slides, slide preparation, assigning and dispatching a prepared case to a pathologist for diagnosis, issuing a diagnosis, collaborative review of problem cases, performing maintenance for case data, and issuing reports.

From a workflow perspective, some of the most important elements of the global workflow exist within the laboratory environment where specimens are received, reconciled, checked in, and ultimately prepared for review by a pathologist. Data collected throughout these processes is used to drive subsequent processes and workflows, including final diagnosis, billing, reporting and report deliver, and various forms of management reporting.

In another embodiment, a management application may be used for a variety of management and administrative functions associated with pathology processes. The application may be available for use through a network, Internet or web connection, and may be used from inside a web browser.

### BRIEF DESCRIPTION OF THE DRAWINGS

FIG. 1 is a diagram of lab process data flows in accordance with one exemplary embodiment of the present invention.

FIG. 2 is a diagram of slide distribution within the specimen lifecycle workflow in accordance with one exemplary embodiment of the present invention.

FIG. 3 is a diagram of the pathology component of the specimen lifecycle workflow in accordance with one exemplary embodiment of the present invention.

FIG. 4 is a diagram of server allocation in accordance with one exemplary embodiment of the present invention.

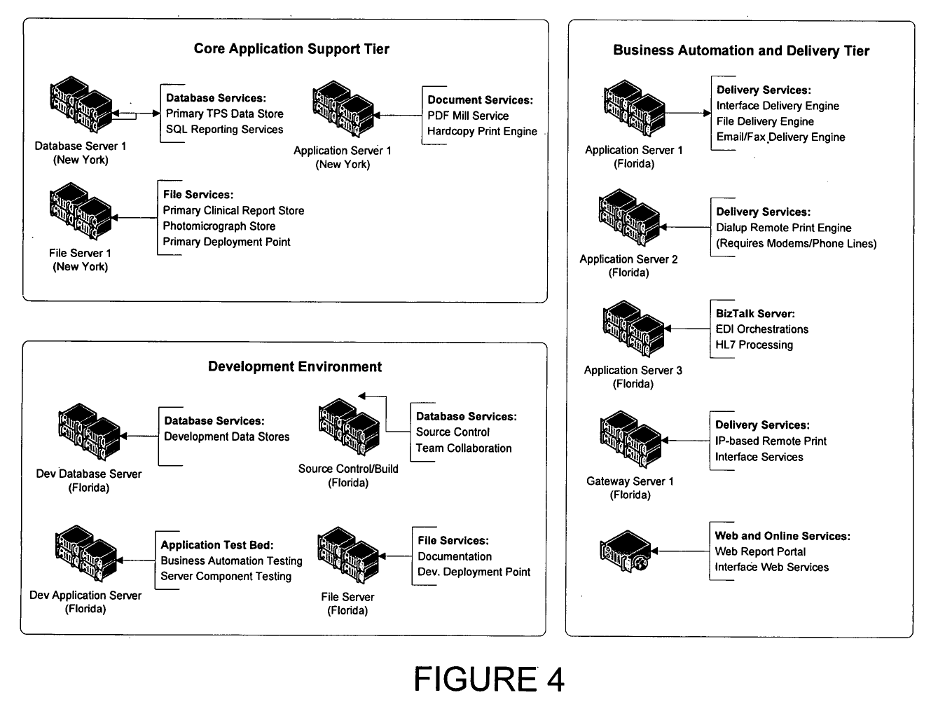

FIG. 5 shows a main screen in a web browser application in accordance with another exemplary embodiment of the present invention.

FIG. 6 shows a Home Screen with a Case Queue.

FIG. 7 shows a search box from the Home Screen.

FIG. 8 shows an Enter Lab Processing Number window.

FIG. 9 shows a Case Detail screen.

FIG. 10 shows a Specimen Detail screen.

FIG. 11 shows an Image Capture screen.

FIG. 12 shows an Image Preview pane in an Image Capture screen.

FIG. 13 shows another Case Detail screen.

FIG. 14 shows a More Information screen.

FIG. 15 shows a Case Notes input pane.

FIG. 16 shows a New Attachment screen.

FIG. 17 shows an Add Special Procedure screen.

FIG. 18 shows a Set Units and Special Instructions pane.

FIG. 19 shows an Edit Cytology Detail screen.

FIG. 20 shows another view of an Edit Cytology Detail screen with variable text box.

FIG. 21 shows an Edit Dipstick Information screen.

FIG. 22 shows a DX Sub-Classification combination box.

FIG. 23 shows a specimen information grid.

FIG. 24 shows an Edit FISH Information screen.

FIG. 25 shows a Microscopic Description field in an Edit FISH Information window.

FIG. 26 shows a Sign Out screen.

FIG. 27 shows a Billing Summary screen.

FIG. 28 shows an Edit ICD9 Selection screen.

FIG. 29 shows a Sign Out screen.

FIG. 30 shows a Pathologist's PIN text box.

FIG. 31 shows an Amendment Text pane.

FIG. 32 shows a Process as Addendum check box.

FIG. 33 shows an Addendum Text Box.

FIG. 34 shows a Pathology Code Control Code Manager screen.

FIG. 35 shows a Cytology Study Control Code Manager screen.

FIG. 36 shows a Urine Cytology Diagnostic Control Code Manager screen.

FIG. 37 shows an Addendum Text Control Code Manager screen.

FIG. 38 shows a Case Comment Control Code Manager screen.

FIG. 39 shows a Master Control Library pane.

FIG. 40 shows Control Code Manager screen.

### DETAILED DESCRIPTION OF EXEMPLARY EMBODIMENTS

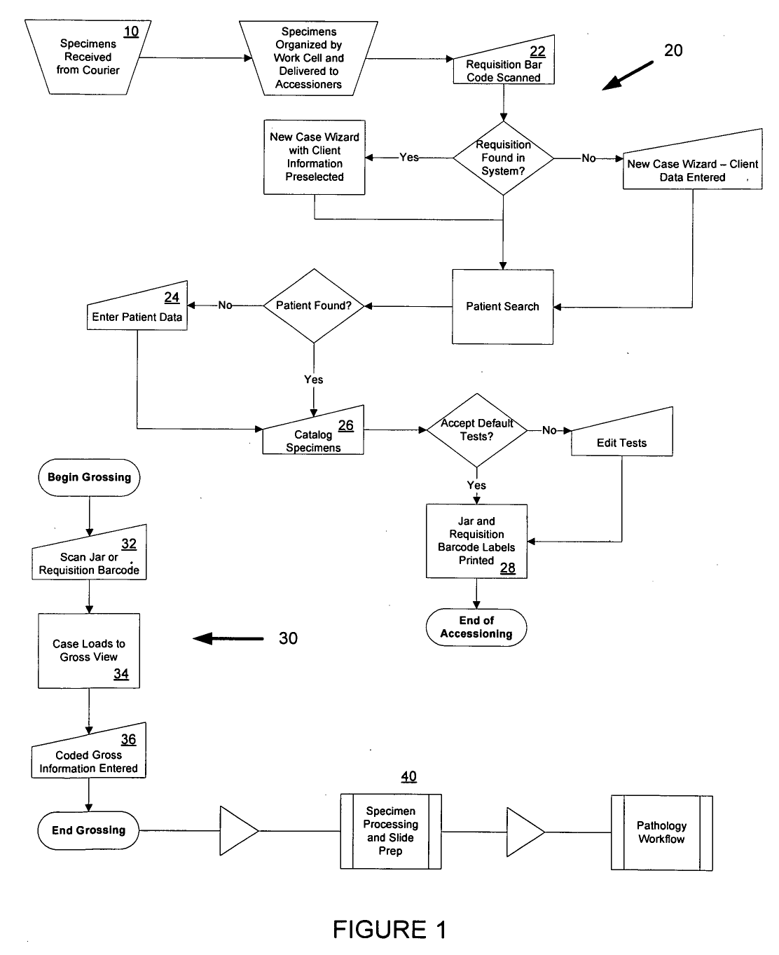

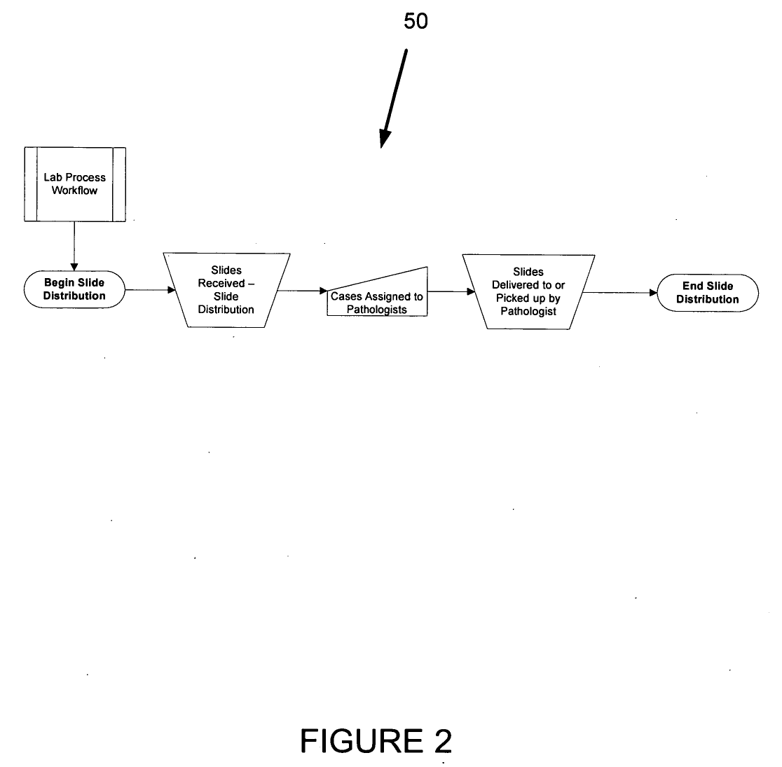

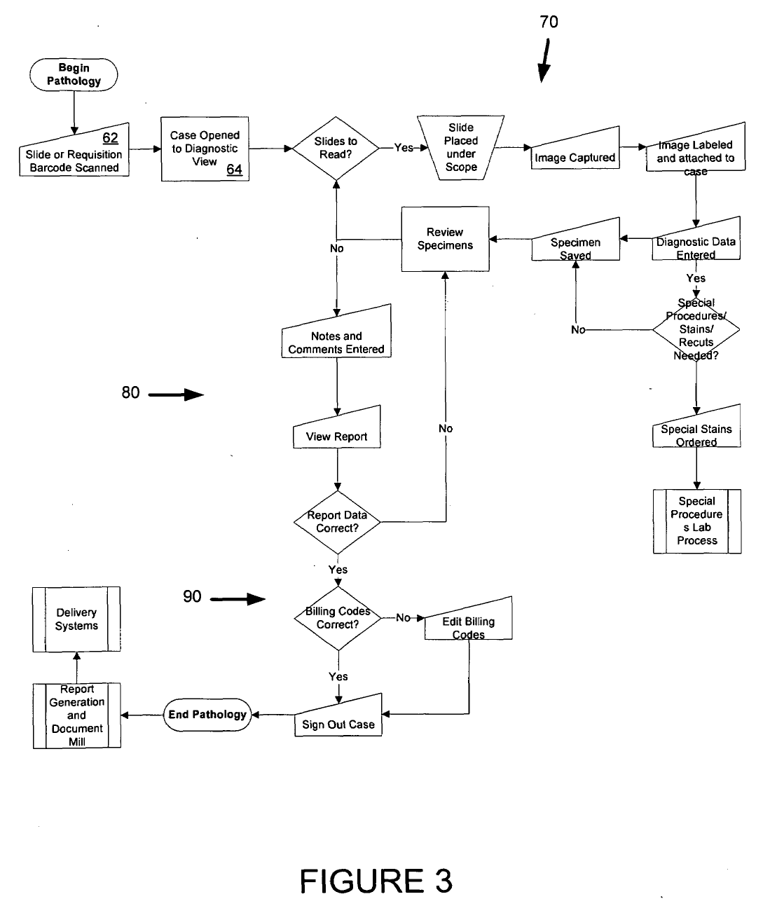

In one exemplary embodiment, the present invention comprises a system and related methods for receiving, processing, managing, reviewing, analyzing, evaluating, and reporting information about pathology specimens and specimen handling. Referring now to the numerous figures, wherein like references identify like elements of the invention, FIGS. 1-3 illustrate an overview of a pathology management system according to one embodiment of the present invention.

A pathology management system provides a functional data environment for receiving and processing incoming specimens, collecting patent information and entering it into the system, preparing individual specimens, embedding specimen-bearing cassettes in paraffin wax, cutting the specimen into thin sheets and mounting them on slides, slide preparation, assigning and dispatching a prepared case to a pathologist for diagnosis, issuing a diagnosis, collaborative review of problem cases, performing maintenance for case data, and issuing reports.

From a workflow perspective, some of the most important elements of the global workflow exist within the laboratory environment where specimens are received, reconciled, checked in, and ultimately prepared for review by a pathologist. Data collected throughout these processes is used to drive subsequent processes and workflows, including final diagnosis, billing, reporting and report deliver, and various forms of management reporting.

The start of the global workflow begins with the receipt by the laboratory of specimens 10. These specimens are received through a variety of means, including delivery by various couriers. The reconciliation process is the subsequent process whereby laboratory staff or personnel compare the specimens brought in with a pick-up log or other tracking means. The primary goal of the reconciliation process is to discover, and correct, any discrepancies that occur, including missed pick-ups or misplaced specimens.

Next is the accessioning process 20, during which data entry personnel, or personnel with that function, collect patient information from requisitions submitted by the client physician, and enter it into the system. Accessioners are the data-entry personnel responsible for completing the accessioning process. A lab manager module is used by accessioners to input the patient data, which may include, but is not limited to, patient name, gender, age, insurance information, and the like. The information is stored in a database attached to a computer or server. Some of the patient or specimen data may be in bar code or similar format, and a bar code scanner may be used with the module as input means.

The next step is the grossing phase 30, which includes an observational stage where the individual specimens are prepared and placed in plastic cassettes by grossing technicians. This typically results in a series of labeled cassettes containing the “cut” tissue. The measurements and other physical properties of the specimens are contained in a “gross description.” Grossing technicians use the lab manager module to enter the specimen's physical properties into the system, where they may be stored in a database.

Next is the specimen processing/embedding process, typically performed at specialized stations by histotechnicians, which encase the specimen-bearing cassettes in a paraffin wax. This process creates a “block” which makes the fine cuts of the microtomy process possible. During the microtomy process, the specimen is cut into a series of thin sheets, which are then mounted on slides. The slide preparation process permanently fixes the thin sheet of the specimen to the slide. A series of default stains may be made. Special stains may be ordered by a pathologist who wishes to review a particular slide, or series of slides, from a different perspective. A pathologist also may order “recuts” if he or she wishes to see slides produced from deeper cuts into the core of the specimen. During this process, the block is usually returned to microtomy processing where the deeper cuts are made. Histotechnicians interact with the lab manager module to complete tasks scheduled by the workflow automation elements of the system.

Functionally, a laboratory may also be broken up into work cells based on major specialty, such as, but not limited to, dermatopathology, urology, etc. These work cells provide specialized processing for particular specimen types.

Managers of various sorts, such as laboratory shift managers and operations management and other executives, also use the lab manager module to monitor workflow and generate and review a variety of reports.

A typical user of the lab manager module initiates a user interface program on a local workstation, personal computer, computer terminal, or similar portal. Security checks may be used, including passwords and network credentialing, to establish a connection between the user interface program and the system.

A particular user may select a default environment for his or her user interface and the implementation of the module. The default environment will provide options and tools suited for that user, and may include the user's typical work cell. Default environments also may be applied to work cells, so that all users operating within a particular work cell see substantially the same options and tools. The module also provides the user the ability to switch between environments on the fly, or as a long-term default environment change. In effect, this permits a user to convert his or her workstation from one work cell to another.

Upon successfully logging into the lab manager system, the user may accomplish a variety of tasks, as described above. For example, the user may open or access a preexisting case by entering appropriate information (such as a case name, number, or other identifier) at a prompt. The information for the case may then be presented in a variety of ways, including pre-set screens and user-configured displays. The user also may wish to find and view a case for which some of the case identification information (such as case number) is missing. A case search function allows the user to locate a case by entering data values, wholly or partially, for searchable fields. The user thereupon is presented with a data grid containing a summary of each case that matches the chosen criteria. The data in the data grid may be sorted in a variety of ways. In one exemplary embodiment, the user may select a given row or entry to review the corresponding case detail.

Upon locating and opening a case, the user may update, modify, or add information concerning the case, and save the changes to the data base. In an exemplary embodiment, the historical data, including all changes or additions, are kept in the database, thus providing the ability to track changes and modifications, including the date the change was made, the date of the last change, and the user making the change.

In another exemplary embodiment, certain system actions, such as the pathology sign-out process, may render a case “locked.” A case is “locked” when it has reached a point in the workflow where no changes may be made to any data that could invalidate the final report. Unlocking the case to allow changes may only be accomplished by certain users, typically medical administrators.

Opening up a new case may be accomplished by an accessioner using similar tools. The accessioner initiates the new accession function. In one exemplary embodiment, the first step in the new accession function is the input of basic requisition information, which may be accomplished by scanning a barcode on a requisition form 22, entering the data manually, or similar input means. Input is checked for errors, such as data being outside expected ranges, or not of an expected type. In some cases, no requisition form or information is provided with the specimen(s). The accessioner, nonetheless, may continue to open the new case, albeit with incomplete or missing information. Cases accessioned without a requisition number or other similar information can be flagged as incomplete and queued for follow-up.

In another exemplary embodiment, new requisitions are printed with an additional bar code beneath the pre-printed bar code containing the physician practice information. The additional bar code contains the account and location information for the requisition's origin. Scanning this bar code as part of the accession function causes the system to supply a filtered “pick list” of only doctors associated with the location. The user may select the submitting physician from the “pick list” and proceed.

Similarly, a requisition may be received where the bar code and printed physician information are missing (such may be the case with a new client, for example). The user may then invoke a physician search function. In one embodiment of this search function, the user enters the physician's last and/or first name, a search is initiated, and a data grid containing a list of possible matches is shown. The user peruses the data grid to locate the appropriate doctor, and selects the corresponding data row or entry to assign that doctor's record information to the new case.

If the user is unable to locate a new case's submitting physician in the data base, the user may choose to add a new physician. The new physician function at this point accepts a minimum amount of information (e.g., first and last name of the physician, if an account and location had already been assigned using the bar code on the requisition; in the absence of this information, the user also would be prompted to choose an account and location under which the new physician would be added). Physicians added during the accessioning process may be flagged as “pending,” thus alerting the account management staff of the need to verify the initial entries, and to complete additional fields (as described below).

Upon assigning a physician to the new case, the accessioner typically will enter the patient's demographic information 24, which usually would be found on the requisition form. Demographic information usually includes, but is not limited to, last name, first name, middle initial, date of birth, social security number, gender, address, city, state, zip code, home phone number, and one or more alternate phone numbers. Each entry may be validated for proper format or data ranges. In one exemplary embodiment, a look-up is performed for possible matches as the user enters each piece of patient demographic information. Possible matches are displayed in a data grid beneath the data entry field, and the user can select one of the records if desired. This helps to ensure that no duplicate patient entries are allowed in the system, and that new cases are properly linked to the correct individual.

Patient insurance information also may be input. Typically, a photocopy of the patient's insurance card is included with the requisition. Where the patient for the new case is a new addition, the insurance information from the photocopy or requisition form must be entered. If the patient was an existing patient, the information provided with the requisition is compared to that currently on file, and if necessary, the system information is updated.

Notes from the submitting physician about relevant conditions the patient has, and other matters, also may be included with the new requisition, often in the clinical data section. These notes are input into the system.

In the embodiment shown, entry of each of the specimens received 26 is next. Typically, this can be performed by scanning the bar coded label on the jar or container containing the first specimen. With the entry, the system compares the code scanned with the requisition number. If the number matches, the accessioner enters the specimen type and site of origin, and proceeds to the next step. If the number does not match, the accessioner takes appropriate steps to determine and resolve the problem.

The accessioner then enters one or more tests, as indicated on the requisition. Each test may be selected from a list box, filtered by case type. Default selections may be provided by the system, based on case type. When all tests on the requisition are entered, a list of specimens associated with the new case is provided. New specimens can be added by repeating the process described above. When the list of specimens is compete, the finish accession button or indicator is selected to complete the accession process for the case in question. A record for the case is marked as “accessioned,” and it is then available for the grossing queue.

In an alternative embodiment, a series of case labels 28 are printed when the accessioning process is completed for a case. These labels may be thermal labels. The labels are placed on each specimen container; typically, two labels will be used for each container (e.g., one on the side and one on the top of a specimen jar). In addition to labels, a series of cassettes may be printed.

The system also provides a pending case queue for the accessioning process, which provides a list of accessions inbound from electronic orders and a list of incomplete cases. In one exemplary embodiment, the queue is presented in an accession detail view (which also may be used for a new case being opened), which displays a composite of all data elements collected as described above. The accession detail view allows for the quick processing of accessions that are marked as incomplete or pending. After the accessioner edits any of the fields, the data may be saved.

In yet another exemplary embodiment, electronic requisitions may be held in the pending case queue. The accessioner receives an e-requisition form accompanied by a number of specimens. This typically occurs at the start of the business day. To process the case, the accessioner opens the queue, performs a lookup for the requisition and opens the case detail. If all of the information on the requisition matches that shown in the system, the accessioner approves the case, thereby invoking the add specimen function described above, allowing the rest of the accession to be handled normally. If not, the differences are reconciled, and the case proceeds as above.

On occasion, specimens may be received in the lab without an accompanying requisition. This may happen as a result of a website error, or a missing or badly damaged requisition. When an accessioner encounters a specimen without its own requisition, and without an apparent tie to an existing case, the specimen should be logged into the system as an orphaned specimen. Opening the orphaned specimen wizard prompts the accessioner to enter the courier of origin, specimen type, quantity, and requisition number (if a label is present on the specimen container). Saving and completing the entry triggers the appropriate messaging action.

If a requisition is found for an orphaned specimen, then the specimens are retrieved from their storage location, and after verifying that the specimen count matches that shown on the requisition, the case is thereafter accessioned normally. The orphaned specimen entry should then be closed out, with a note or indication as to the final outcome.

Similarly, occasionally requisitions arrive with no specimen. This may be due to the client failing to include it in the shipment, or to mishandling by the courier. In an exemplary embodiment, the missing specimens are treated as emergency issues. Once the accessioner has confirmed that the specimen is missing, the accessioner opens a new case as above, but at the point of adding a specimen, the accessioner instead selects an option to save the case as a missing specimen case. This generates a series of activities for supporting members of the team. If and when the missing specimen is located and received, the accessioner verifies that all team members are aware of the outcome, and proceeds to complete the case by opening it from the pending accessions queue, and adding in the specimens as described above.

Cases that have completed the accessioning process are marked as “accessioned” and are ready to be grossed. Such cases may be placed in a “cases to be grossed” queue. A grosser who opens the lab manager program at the start of the workday may be presented with this queue as a default. Activating any case shown in the queue will open its detail window. The grosser also may use the case search function, or activate a filter. Some filters include, but are not limited to, cases grossed by the grosser, cases grossed yesterday, cases to be grossed, and overdue cases (i.e., cases that were accessioned more than a day ago).

To begin grossing a case, the grosser picks up the case requisition and scans the bar code 32 affixed to it at the end of the accessioning workflow. This causes the system to open the case containing the accession number in the bar code. If the accessioner is already viewing a case, the accessioner may be prompted to confirm that he or she wishes to open a different case, and if the response is yes, then he or she may be prompted to save or discard any changes made in the previously opened case.

Upon opening the case, the grosser is presented with a case detail view or gross view 34, showing a grid containing each of the specimens entered during the accessioning phase. Selecting the row corresponding to a particular specimen will open the detail for that specimen. The system may then prompt the grosser to scan the bar code label on the specimen container for that specimen to verify that the accession number on the container label, printed at accessioning, matches the one assigned to the current case.

For each specimen, the grosser enters a series of observations 36 which are ultimately combined into a gross description. Using entry fields provided in the grid view, the grosser enters information about the media the specimen was received in (e.g., no preservant, alcohol, formalin, etc.), label text, measurement (e.g., length, width, depth), color (white/yellow, pink, tan, etc.), cassettes (the number of cassettes for the current specimen), the number of pieces distributed among the total number of cassettes, sectioning information (e.g., no section—the default, bisected, trisected, serially sectioned), and whether the specimen is inked or not.

After the above information is entered, the system generates a gross description for the specimen, and displays it in a text field. The text is comprised of a standard format for the specimen type with variables for the user-entered fields. E.g., Received in formalin labeled with the patient's name and ‘R. Breast’ is a white/yellow portion of fibro-adipose tissue measuring 3.0×2.0×1.0 cm. The specimen is inked and serially sectioned. The specimen is entirely submitted in one cassette. The grosser may adjust the gross description at any time prior to saving the case. The grosser may save the case, or save the case as grossed. The first saves the case without moving it out of the grossing workflow. The second marks the case as grossed and makes it available to the next clinical phase.

In another embodiment, the system provides a series of lab manager functions for medical department workflow. These functions include case assignment 50 (the process wherein prepared cases are dispatched to a pathologist for diagnosis), case diagnosis (the phase where each case is reviewed by a pathologist and a diagnosis is issued; also known as a “sign-out,” this process results in all medical data being finalized and case files being locked), pathologist conference (occurring on any difficult or malignant case, a group of pathologists confer with the goal of ruling out the possibility of a false diagnosis through collaborative review of the problem case), case maintenance (changes made by a medical staff member to case information after final sign-out to correct clerical errors, issue an amended or corrected report, or issue a report addendum to reflect further findings on a case), and manual reporting (printing and sorting of hard copy reports for shipment by courier or mail or similar service for clients opting to receiving hard copies). Additional medical workflow elements include, but are not limited to, slide requests (provision of original slides to a client or referring physician upon request from the patient or physician, sometimes to assist in the solicitation of a second opinion where a positive diagnosis has been issued; this service requires medical staff members to track certain information regarding the original request and monitor the timely return of all case materials), corporate send-outs (provision of a specimen to a contracted lab for final diagnosis, where the lab has contracted with certain laboratories who offer services that it does not, allowing one-stop-shopping for anatomic pathology and clinical needs), medical send-outs (shipment of case materials, e.g., blocks and slides, to an outside party, such as a hospital or university), specimen processing (ordering and tracking of additional slides from the laboratory, such as a re-cut to establish a deeper section, or the addition of a special stain).

In one exemplary embodiment, a staff pathologist receives the case materials for his or her assigned case load. To begin reading the first case, the first slide is removed from its tray and passed under a bar code reader 62. This causes the system to open the case detail view 64 for the relevant case. If a case already has been loaded, the pathologist may be prompted to confirm whether he or she wishes to close the current case and proceed.

In some cases, the pathologist may wish to open a case for which he or she has a case number, but no functional bar code. The pathologist initiates the open case function, enters the desired case number in the open case dialog box, and is presented with the case detail view, as above. If the case number is not found, the pathologist is prompted to re-enter the number, or open another case.

In other cases, the pathologist may wish to open a case for which he or she has no case number or functional bar code (e.g., only a requisition form with the patient's personal information). The pathologist then initiates the case search function, enters the values to search for in the appropriate text fields, leaving those corresponding to missing information (e.g., case number) blank. The search is then performed, and a data grid containing a summary of each case matching the entered criteria is presented. The grid may be sorted by clicking any of the grid's columns. Selecting a given row provides the corresponding case detail view. The pathologist also has the option to perform a new search if the results do not help identify the desired case, or return to another function in the system.

Upon selecting and opening the appropriate case, the pathologist performs his or her work with the slide 70, enters or updates case information, and saves it, which commits all of the updated information to the system data base. The pathologist can verify that the save was successful by checking the last updated field displayed on the case detail screen.

In one exemplary embodiment, the system includes a series of laboratory outreach components to manage and execute the delivery of clinical reports through a variety of automated means. The remote print subsystem facilitates the delivery of full-color printed reports at client locations. The remote print subsystem may be part of the core system, but also may be an external component with access to the core system through a bi-direction EDI interface.

As each case completes its clinical workflow, the system sends a notification to the remote print subsystem 80, thereby beginning the delivery process. The transmittal contains all of the data necessary for the remote print action to be processed. The system receives and process continual updates from the remote print subsystem. To accomplish the required remote print functionality, the remote print subsystem's responsibilities are two-fold. First, it must assemble and transmit remote print jobs using available communications means. The system manages initiation of the relevant connection and transmission of the report file. Second, as the status of each remote print action changes, the subsystem must provide updates for consumption for the main system and its users.

In another exemplary embodiment, the system includes a billing interface and application 90 to allow the billing personnel or department to perform the functions required to bill for the services provided. A large subset of the billing workflow is automated, reducing manual processes by about 50%. A particular case can be opened by billing personnel in the manner described above, and information added or edited likewise.

In yet another exemplary embodiment, the system includes a module that allows the client service and other logistical departments to seamlessly interact while performing the functions required to serve and maintain the laboratory's client base. The system provides a user interface for the management of all of the manual logistical processes, and each of the other applications in the system has the ability to generate workflow items or activities for the client management module.

The client management module allows users to create new accounts, which involves the addition of locations, contacts, courier information, default delivery setting, client physicians (including credentials and associate locations), and pathologist preferences. The module further includes the ability to submit and track supply orders, arrange for pick-up requests, handle new slide requests, and monitor the status of cases.

In another exemplary embodiment, a requisition printing module is available for use by supply clerks to customize requisition forms and ship specimen collection supplies.

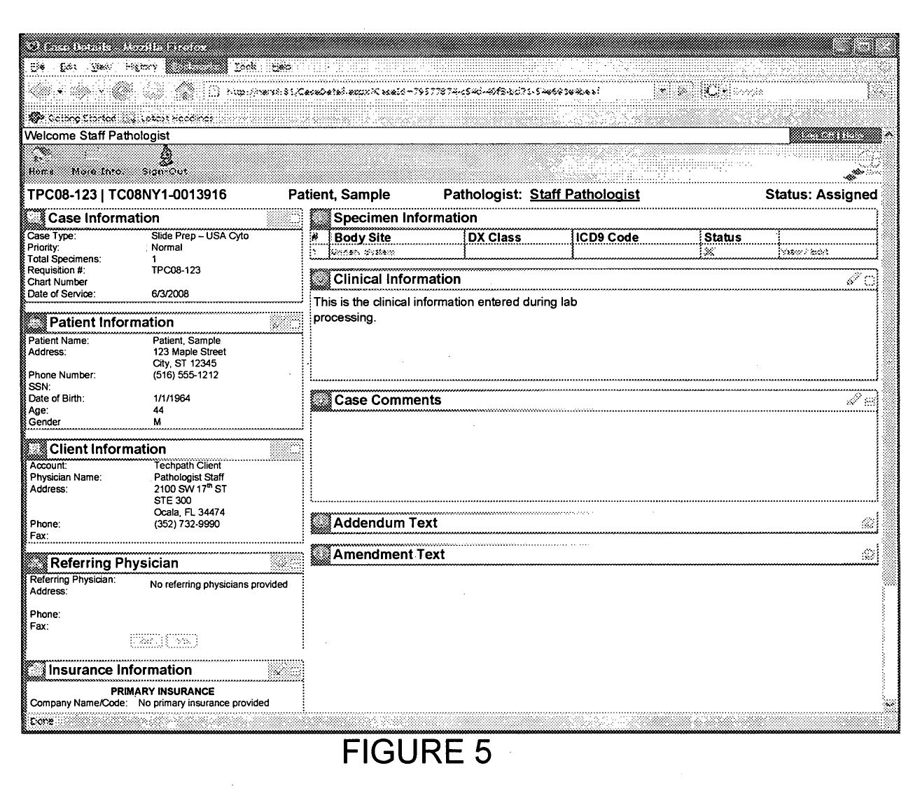

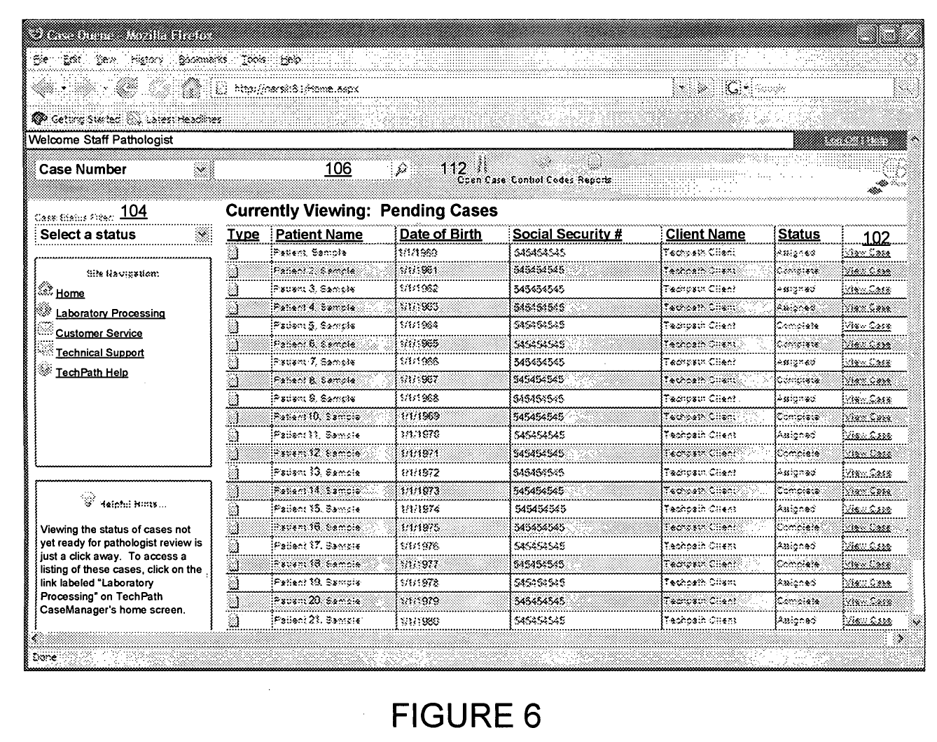

In one exemplary embodiment, a management module (referred to herein as the “TechPath module”) may be used for a variety of management and administrative functions. TechPath may be available for users through a network, Internet or web connection, and may be used from inside a web browser. Once logged into the TechPath module (see FIG. 5), the user is directed to the Home Screen, as seen in FIG. 6. It is from this screen that the user is able to search for and open a case.

All non-finalized cases that are associated with one of the user's accounts are displayed in the Case Queue, as seen in FIG. 6. The user is able to open a case from the Case Queue by clicking the View/Edit link 102 on the right side of the data grid. Once the user clicks this link, the case will be opened in the Case Detail screen. They also may filter this list by case status using the Case Status Filter 104, which is shown in the upper left corner of FIG. 6.

The user is able to search for any case that is associated with one of the user's accounts by means of the Case Search function 106. In one exemplary embodiment, to search for and open a case, the user takes the following steps.

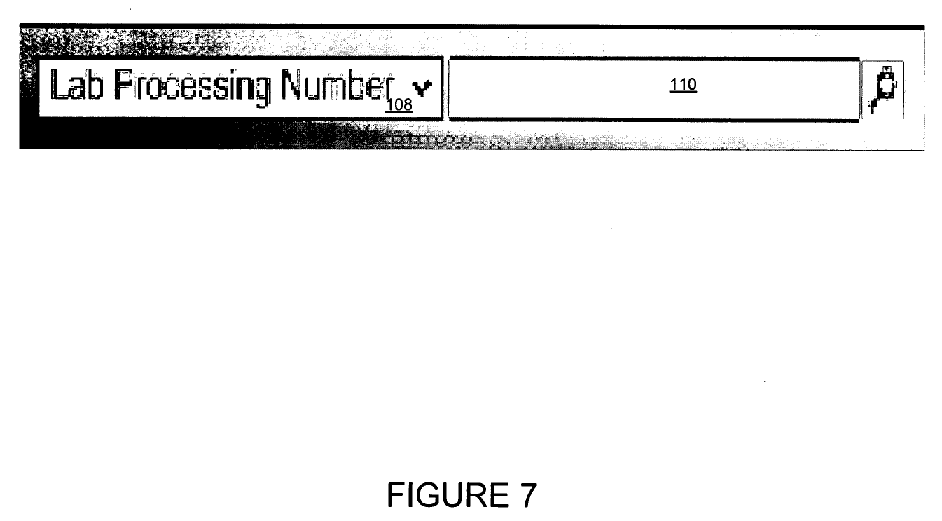

1. In the drop down list (see FIG. 7) on the top left of the Home Screen, the user selects the data type for which he or she would like to search (e.g., lab processing number 108, patient name, etc.).

2. In the text box 110 to the right of the data type selector, the user enters the text for which he or she would like to search (e.g., TC08NY1-0013000, if case number is selected, or John Smith, if patient name is selected).

3. The user hits the Enter key or clicks the magnifying glass icon to run the search.

4. The results will be displayed.

In one exemplary embodiment, this is an open search, so results will be returned for any entry containing the search string. Thus, if the user is searching for case TC08NY1-0013000, and enters 13000 in the search box, all cases with 13000 (e.g., TC08NY1-0130000 and TC08NY1-0013000) will be returned in the results.

Alternatively, users can open a case using the “Open Case” function, in combination with a barcode scanner or typing in the accession number of the case. In one embodiment, this may be accomplished by the following steps:

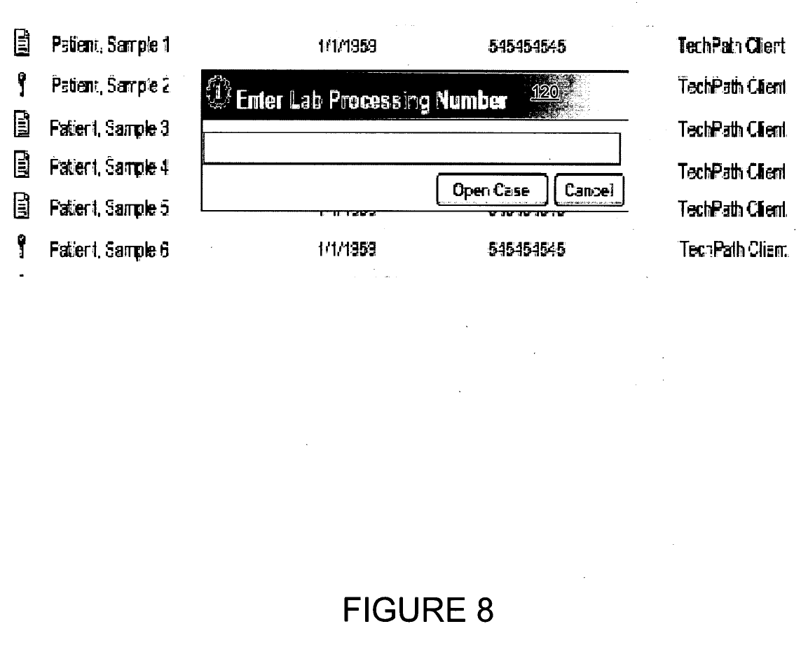

1. Once logged into TechPath and navigated to the Home Screen, the user clicks the Open Case icon 112 at the top of the screen. This will open the Enter Lab Processing Number window 120 in the center of the screen, as seen in FIG. 8.

2. In the Enter Case Number window, the user enters the accession number, either by utilizing a barcode scanner or typing in the accession number.

3. The user then clicks the Enter key or hits the Open Case button. If a valid accession number was entered, the case will open in the Case Detail.

When the user opens a case, the information for the case is displayed on several screens. These are primarily the Case Detail, Specimen Detail, More Information, and Sign Out screens.

The user also may enter a diagnosis for a specimen by the following steps:

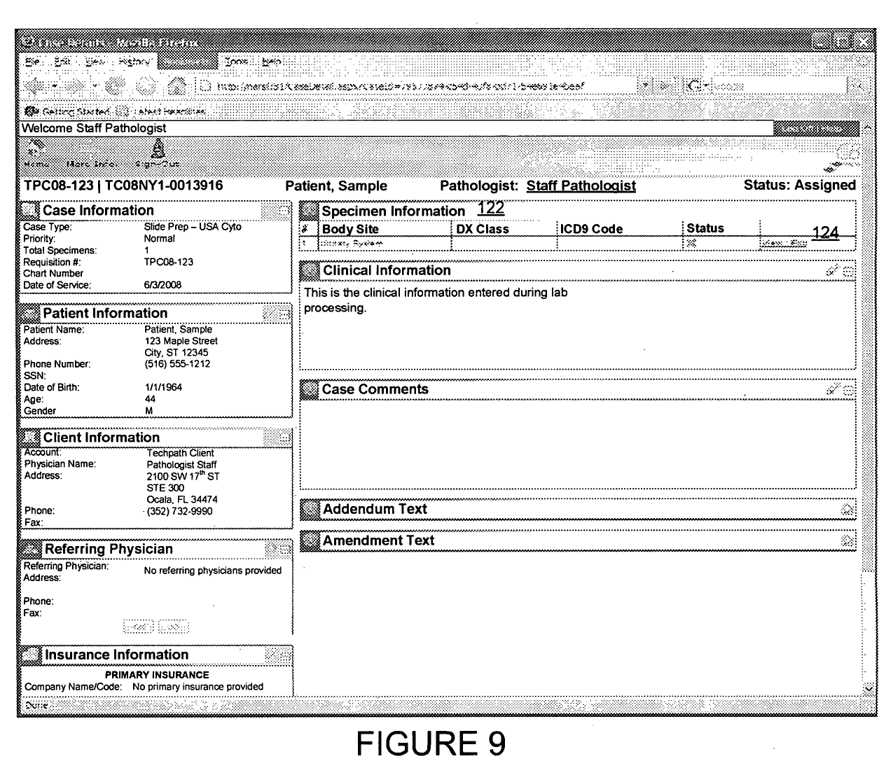

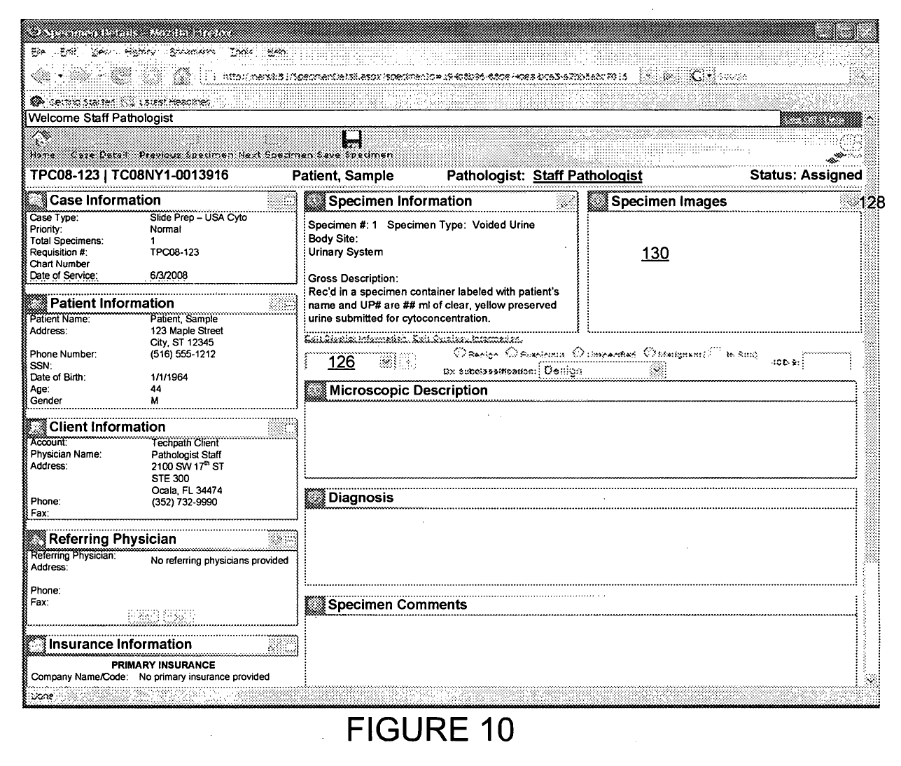

1. When the case opens in the Case Detail, as seen in FIG. 9, there is a data grid 22 that displays all of the specimens associated with the case. The user clicks the View/Edit link 124 to enter the diagnosis for a specimen; this will load the Specimen Detail, as seen in FIG. 10.

2. In the Specimen Detail, the user types the relevant control code in the Control Code combo box 126, or selects it from the drop down list. The user then clicks the +button or presses the Enter key. This will load information from the control code into the relevant fields. (A control code is a pre-entered set of text that the user creates to assure consistent text fills in a given field.)

3. The user selects and loads additional control codes to build text in the text boxes.

4. Alternatively, the user can type the microscopic description, diagnosis text and notes in the corresponding text boxes and select the diagnostic classification to enter the information.

5. The user can add an image for the specimen as described below.

6. Once the information has been entered for a specimen, the user clicks the Save Specimen icon at the top of the screen.

7. If there are multiple specimens, the user can then use the Next and Previous Specimen function to navigate through the specimens.

8. Once the user has diagnosed all of the specimens, the user can sign out the case.

Certain case types contain additional screens, as described below.

Images may be attached to a specimen. This allows images to be displayed on reports, or saved with a case. In one embodiment, the following steps may be followed to attach images:

1. From the Case Detail, the user opens the specimen to which the image will be attached.

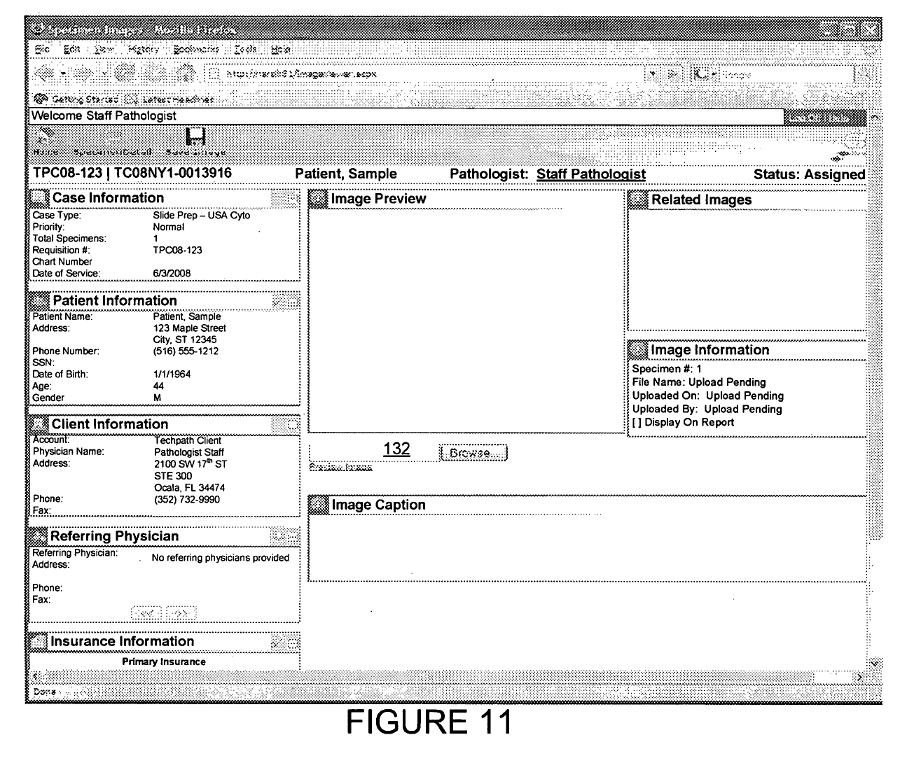

2. In the Specimen Detail, the user clicks the + button 128 in the upper right corner of the Specimen Images data grid 130. This will open the Image Capture screen, as shown in FIG. 11.

3. The user selects the image file and uploads it to TechPath.

4. The file path will appear in the text box 132 to the left of the Browse button.

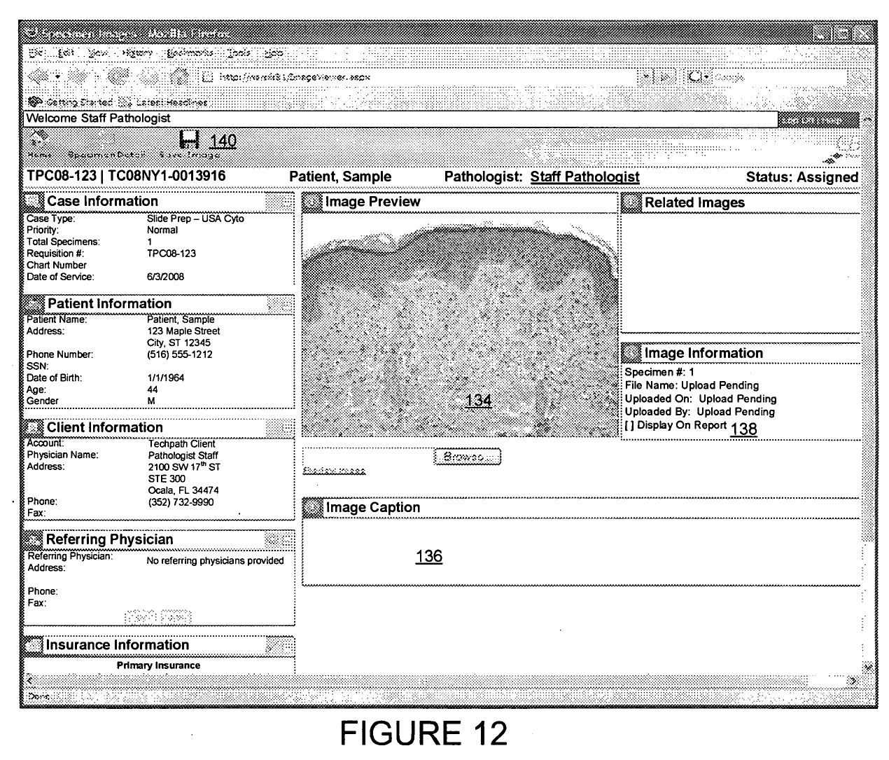

5. The user clicks the Preview Image link to load the image in the Image Preview pane 134, as seen in FIG. 12. This must be done to allow the image to be saved.

6. The user enters a caption in the Image Caption text box 136 if one is to be displayed on the final report.

7. If the user does not want this image displayed on the final report, he or she may uncheck the Display on Report check box 138.

8. The user then hits the Save Image icon at the top of the screen. The information entered will now be displayed on the Image Capture screen and the user can return to the Specimen Detail to continue processing the case.

Case comments are displayed on the final report as a block of text, allowing a pathologist or user to enter general comments about the overall case. In one embodiment, a case comment is entered by the following steps:

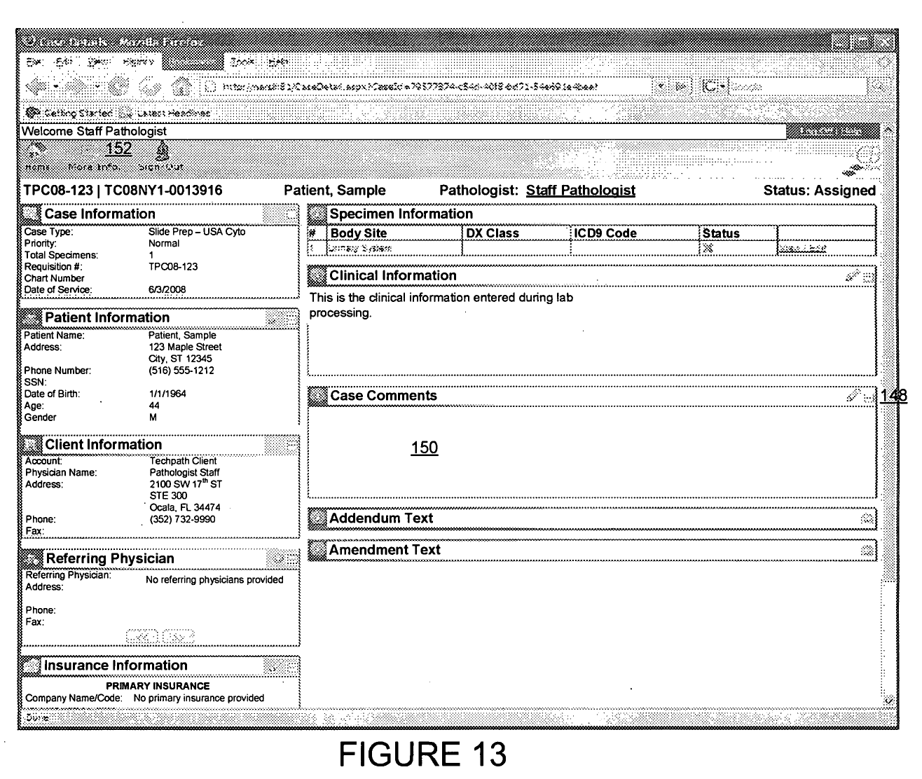

1. Once the user has opened the case in the Case Detail screen (FIG. 13), the user clicks the pencil (or other) icon 148 on the top right corner of the Case Comments pane 150.

2. This will make the Case Comments field writable so that the user can add or edit case comments.

Case Notes, in contrast to Case Comments, are notes that are stored with a case for review by individuals working with the case. Case Notes are not displayed on the final report. In one embodiment, Case Notes can be added by the following steps:

1. Once the case has been opened, the user clicks the More Information icon 152 on the top of the Case Detail screen.

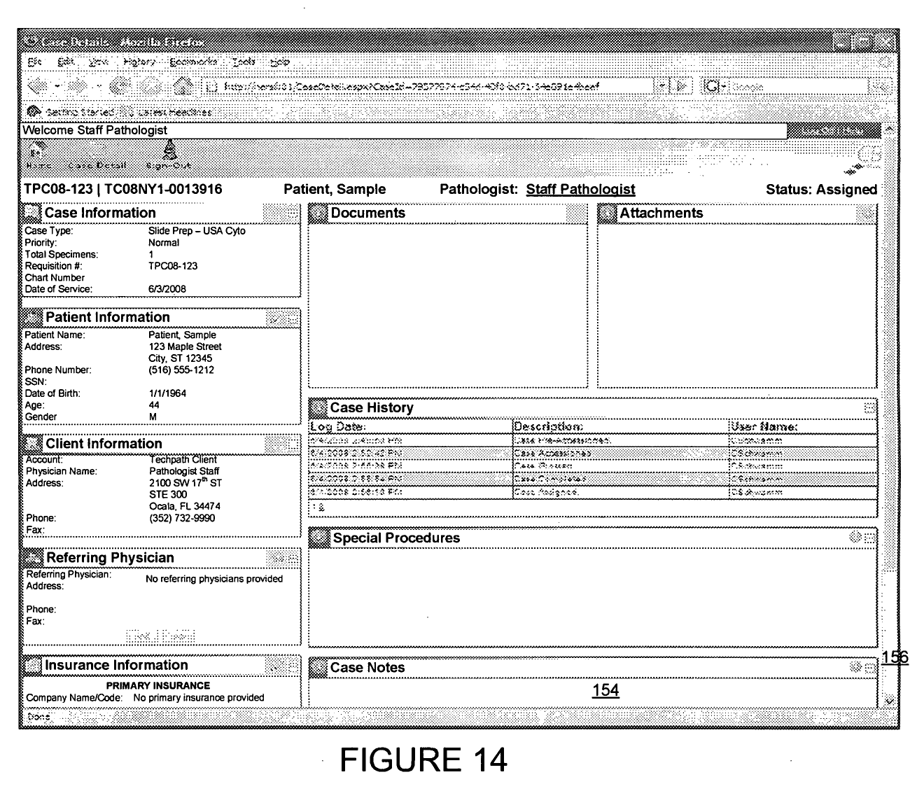

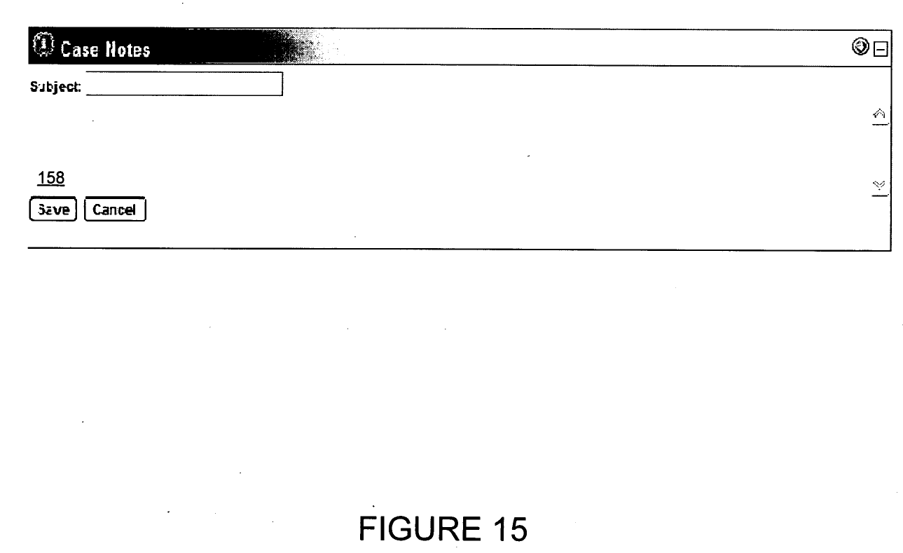

2. In the More Information screen (FIG. 14), the user clicks the + button 156 on the Case Notes pane 154. This will open the Case Notes in a writable format, as seen in FIG. 15.

3. The user then enters a subject and note and hits the Save button 158.

Case notes that have been entered previously may be viewed by clicking the View link beside the subject in the data grid. The note will open in a read-only format.

Case attachments are files that are saved along with a case (e.g., text documents, Adobe PDFs or images). They are used for review by those working with the case, and usually are not delivered to clients. In one exemplary embodiment, case attachments are added by the following steps:

1. Once the case has been opened, the user clicks the More Information icon on the top of the Case Detail.

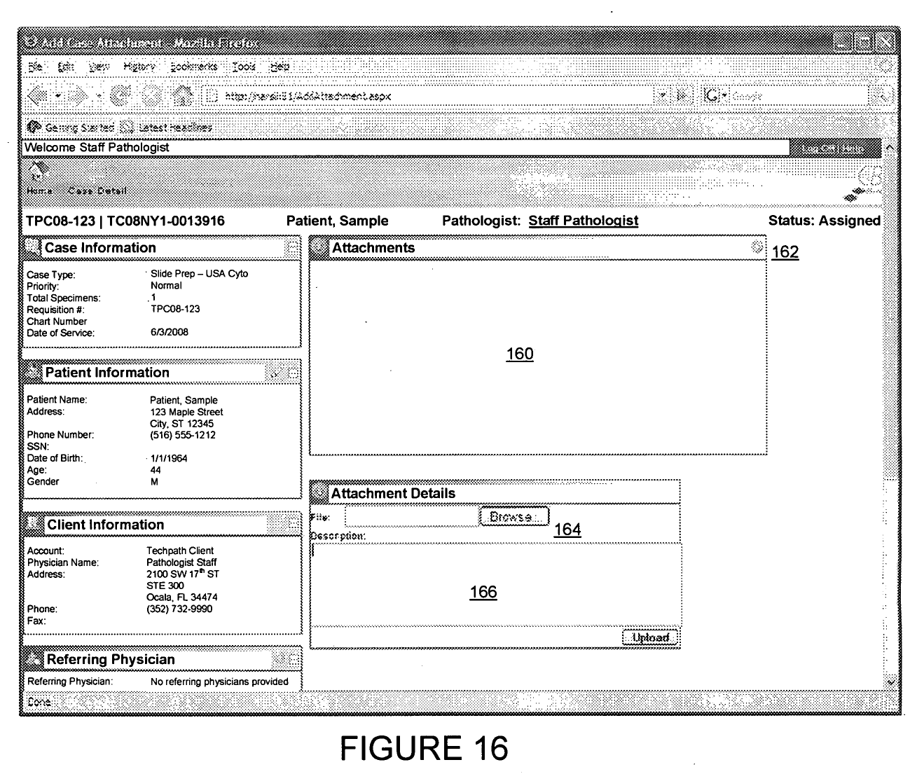

2. In the More Information screen, the user clicks the + icon 162 in the Attachments pane 160. This will open the New Attachment screen 164, as seen in FIG. 16.

3. In the New Attachment screen, the user clicks the Browse button to select a file to attach.

4. The user enters any notes that he or she wants to associate with the file in the Description text box 166.

5. The user then clicks the Upload button to attach the file to the case.

Case attachments may be viewed by navigating to the More Information screen, and clicking on the View link next to the file name.

Special procedures include any additional special stains or re-cuts to be performed on a specimen. Special procedures may be ordered by taking the following steps:

1. Once the case has been opened, the user clicks the More Information icon on the top of the Case Detail.

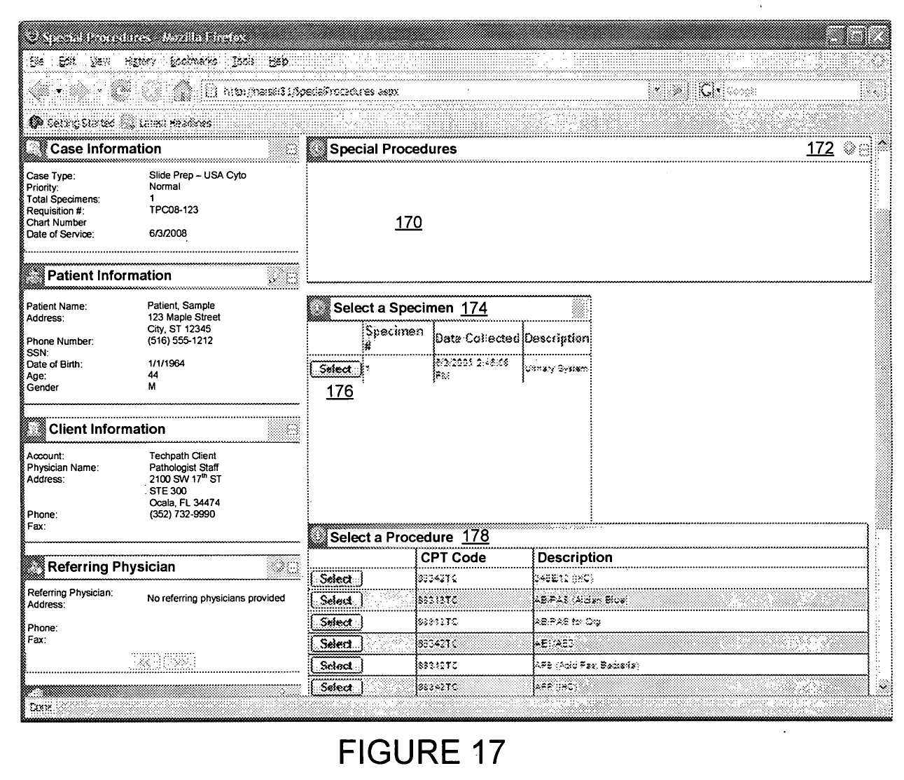

2. In the More Information screen, the user clicks the +button 172 in the Special Procedures pane 170. This will open the Add Special Procedure screen 174 (FIG. 17).

3. The user selects the specimen for which to order a special procedure by clicking the Select button 176 next to the specimen.

4. The user selects a procedure to be run on the specimen. Special stains and re-cuts are both listed in the Special Procedure pane 178.

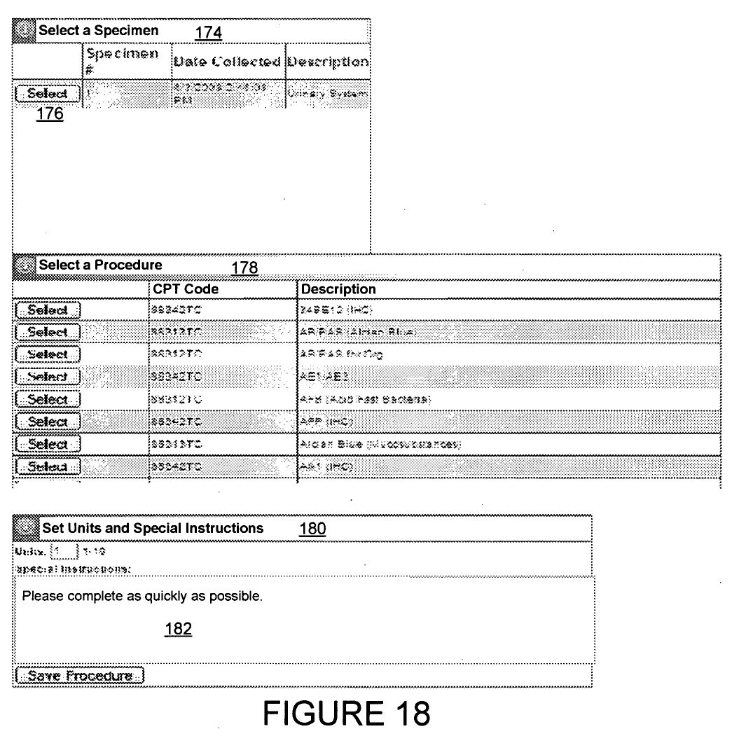

5. The user enters the number of units in the Set Units and Special Instructions pane 180 (FIG. 18).

6. If there are any instructions for the processing of this procedure, the user enters them in the Special Instructions text box 182.

7. When all of the necessary information has been entered, the user clicks the Save Procedure button.

Special procedures that have been ordered for a case may be viewed and edited by navigating to the More Information screen of the Case Detail. This screen displays a list of special procedures that have been ordered for the case. There the user can change the number of units for the procedure, add additional special instructions, or cancel the procedure.

There are certain case type-specific screens that contain information which is only relevant to specific case types, such as cytology detail summaries for cytology cases. Described below is more information about these screens and their associated case types.

The Edit Cytology Information screen allows the user to edit information that appears in the Cytology Detail Grid on the final report. This screen is only accessible for cases of the following types:
Slide Prep-AP Cyto
Slide Prep-Breast Cyto
Slide Prep-H/N Cyto
Slide Prep-Urine Cyto
   To edit information in this screen, the user takes the following steps:

1. After opening a case in one of the above noted case types, the user navigates to the Specimen Detail.

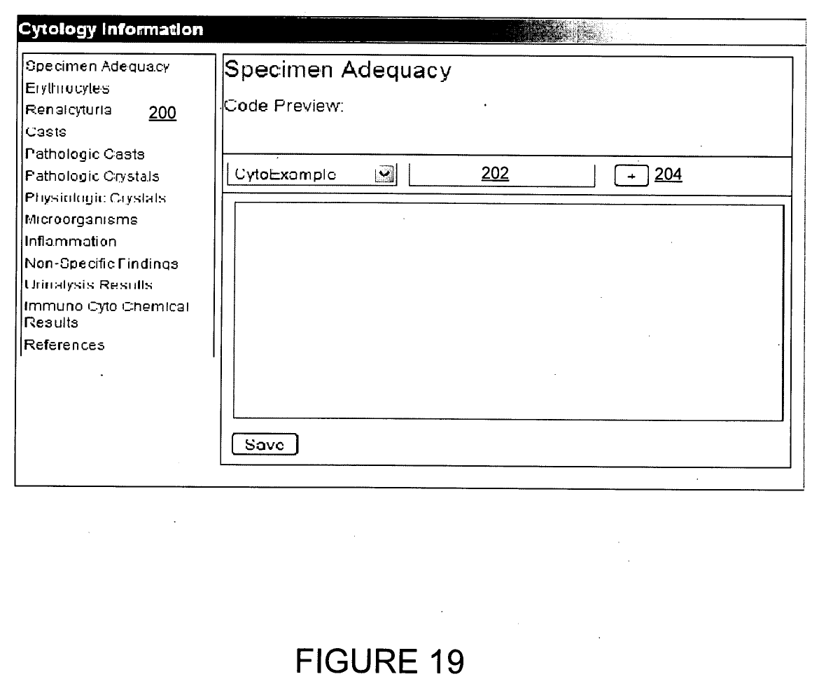

2. In the Specimen Detail, the user clicks the Edit Cytology Information link. This will open the Edit Cytology Detail screen, as seen in FIG. 19.

3. In the Edit Cytology Detail screen, the user selects the summary to be edited by clicking the corresponding link 200 (e.g., Erythrocytes, Casts, etc.). Specimen Adequacy is loaded by default.

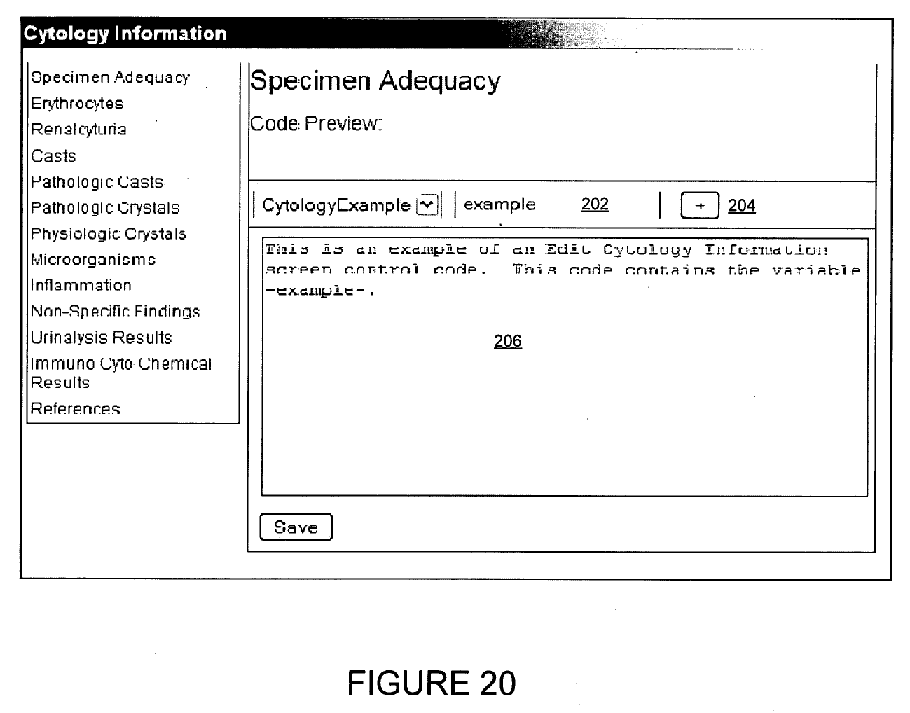

4. To use Cytology Study control codes, the user selects the code in the Control Code combo box. The user enters any variable text in the variable text box 202 to the left of the + button 204, then presses the + button. This will load the code and replace the caret symbol with the text from the variable text box (FIG. 20).

5. The user repeats Step 4 as needed with different control codes to build the complete text 206 that is needed.

6. After the text for a given category is complete, the user clicks the Save button.

Once information for all applicable categories has been filled out, the user can return to the Specimen Detail to continue processing the case. Otherwise, the user can click the Specimen Detail arrow icon to return to the Specimen Detail.

The Slide Prep-Urine Cytology case type has the Cytology Details screen as well as an Edit Dipstick Information screen to include additional information in the final report. Slide Prep-Urine Cytology case types also include DX Sub-Classification; this will be described after the additional screen information.

The Edit Dipstick Information screen allows the user to see and edit the information from the dipstick test performed in the lab. This screen is only viewable for Slide Prep-Urine Cyto case types. To access and edit this information, the user takes the following steps:

1. After opening a Slide Prep-Urine Cyto case, the user navigates to the Specimen Detail.

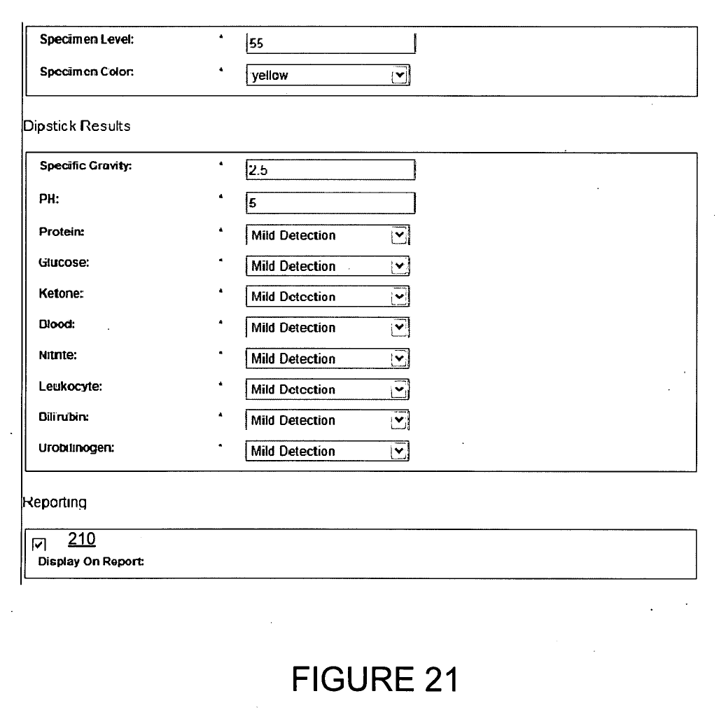

2. In the Specimen Detail, the user clicks the Edit Dipstick Information link to open the Edit Dipstick Information screen, as seen in FIG. 21.

3. In this screen the user is able to view and modify the information recorded from the dipstick analysis. The user also is able to choose whether the dipstick information will be displayed on the report via the Display on Report check box 210.

4. If the user has modified any information, the user hits the Save button and continues processing the case. Otherwise, the user clicks the Specimen Detail arrow icon to return to the Specimen Detail.

The DX Sub-Classification is recorded in order to include information for subsequent reports for the same patient. So, if a patient's Slide Prep-Urine Cytology case is processed, and then a later Slide Prep-Urine Cytology case is processed, the DX Sub-Classification of the first case is displayed on the second case's final report. To enter a DX Sub-Classification, the user takes the following steps:

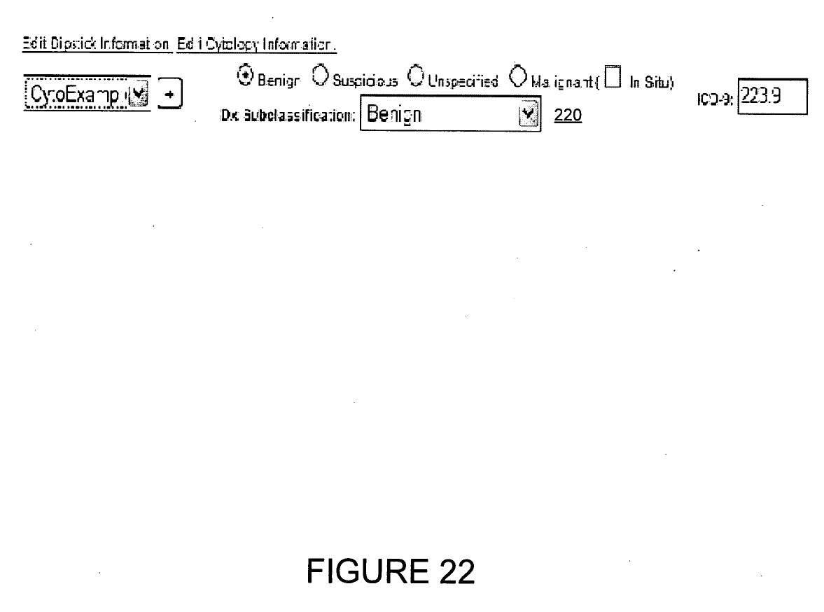

1. In the Case Detail of a Slide Prep-Urine Cytology Case, the user selects the DX Sub-Classification in the DX Sub-Classification combo box 220 above the Microscopic Description textbox, as seen in FIG. 22.

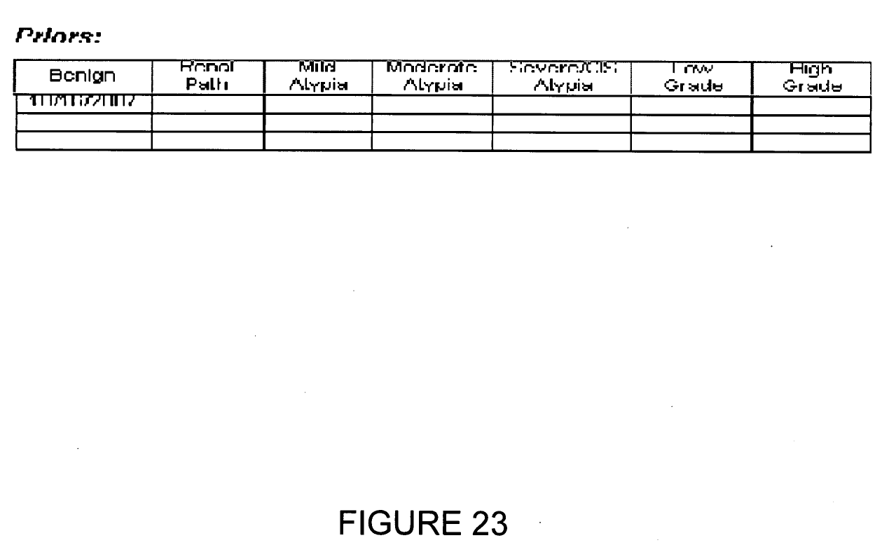

2. Once all other specimen information is entered in the Case Detail, the user clicks the Save Specimen button. The information will appear in the subsequent final reports in the grid illustrated in FIG. 23. The grid will give the date of the previous case in the column corresponding to the DX Sub-Classification.

The Slide Prep-UroVysion case type includes the FISH Details screen that will show additional information on the final report. Moreover, the Microscopic Description, Diagnosis, and Note textboxes connect to the final report in a manner different than standard cases. How to fill these out and how they correspond to the final report is described below.

The Edit FISH Information screen allows the user to see and edit the information from the FISH test performed in the lab. This screen is only viewable for Slide Prep-UroVysion case types. To access and edit this information, the user takes the following steps:

1. After opening a Slide Prep-UroVysion case, the user navigates to the Specimen Detail.

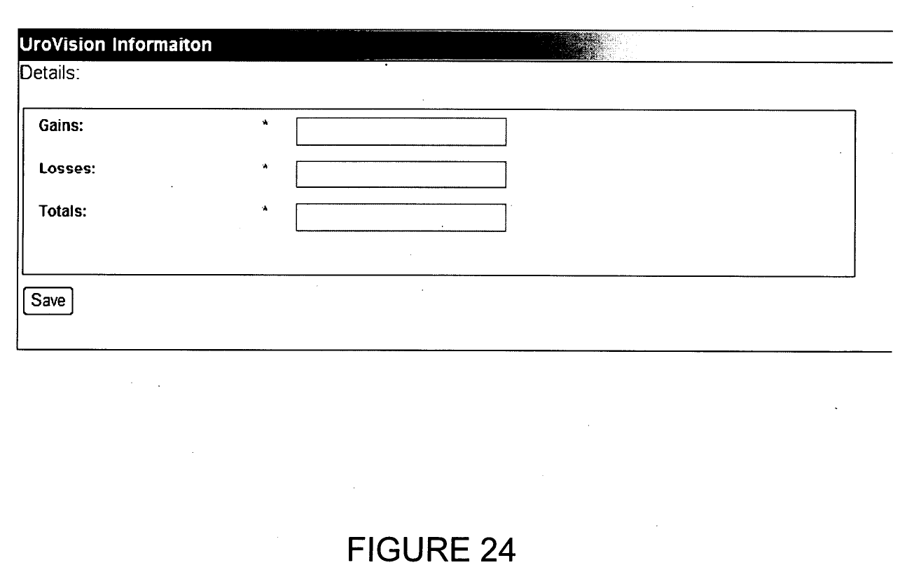

2. In the Specimen Detail, the user clicks the Edit FISH Information link. This will open the Edit FISH Information screen as seen in FIG. 24.

3. In this screen, the user is able to view and modify information recorded from the FISH test.

4. If any information is modified, the user hits the Save button and continues processing the case. Otherwise, the user clicks the Specimen Detail arrow icon to return to the Specimen Detail.

The Microscopic Description, Diagnosis, and the DX Classification fields connect to the final report in a different manner than standard report. How to fill these fields out and how they connect to the final report are described below.

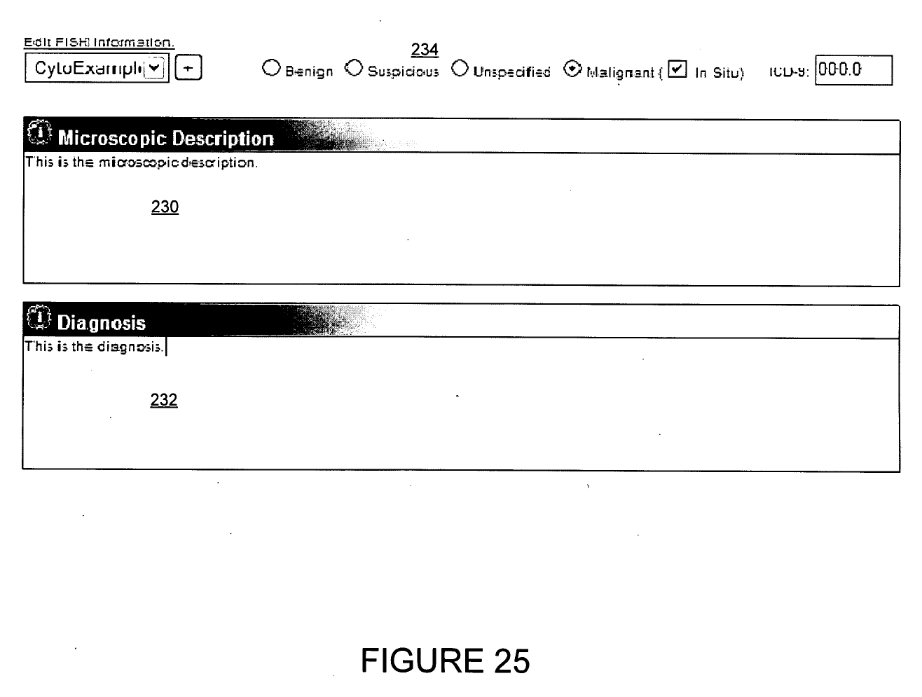

1. In a Slide Prep-UroVysion case, the user enters the description in the Microscopic Description field 230, as shown in FIG. 25.

2. The user enters the result in the Diagnosis field 232.

3. To indicate a positive or negative result, the user utilizes the DX Classification radio buttons 234. To indicate a positive result, the user selects the Malignant radio button. To indicate a negative result, the user selects any radio button other than malignant. Once these have been entered, the user hits the Save Specimen button and continues processing the case.

The TechPath module may also be used to edit billing information. The user can edit CPT codes associated with a case for all initial sign-outs, and in some instances can select ICD9 codes associated with a specimen.

In one embodiment, the user can only edit ICD9s if users have used multiple control codes for specimen diagnosis that have ICD9s associated with them. When multiple control codes with varying ICD9 codes are used to diagnose a specimen, this is referred to ICD9 stacking. Additionally, a user is only able to edit billing information prior to the initial sign out of the case.

To edit CPT codes, the user takes the following steps.

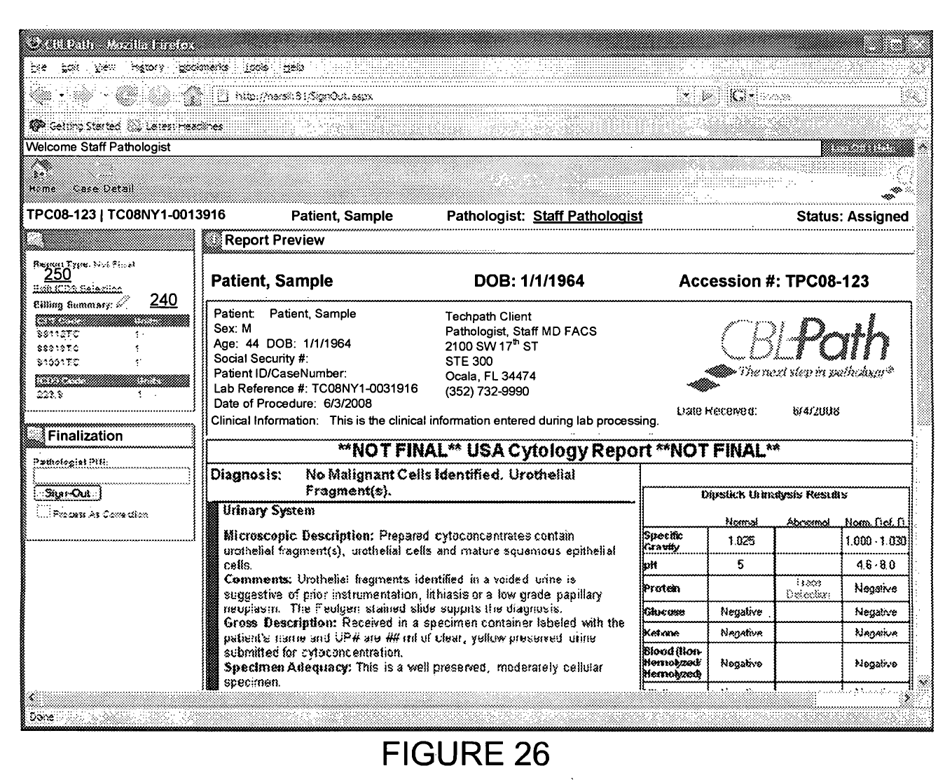

1. Once a case is ready to be signed out, the user clicks the Sign Out icon at the top of the Case Detail. This will open the Sign Out screen as seen in FIG. 26.

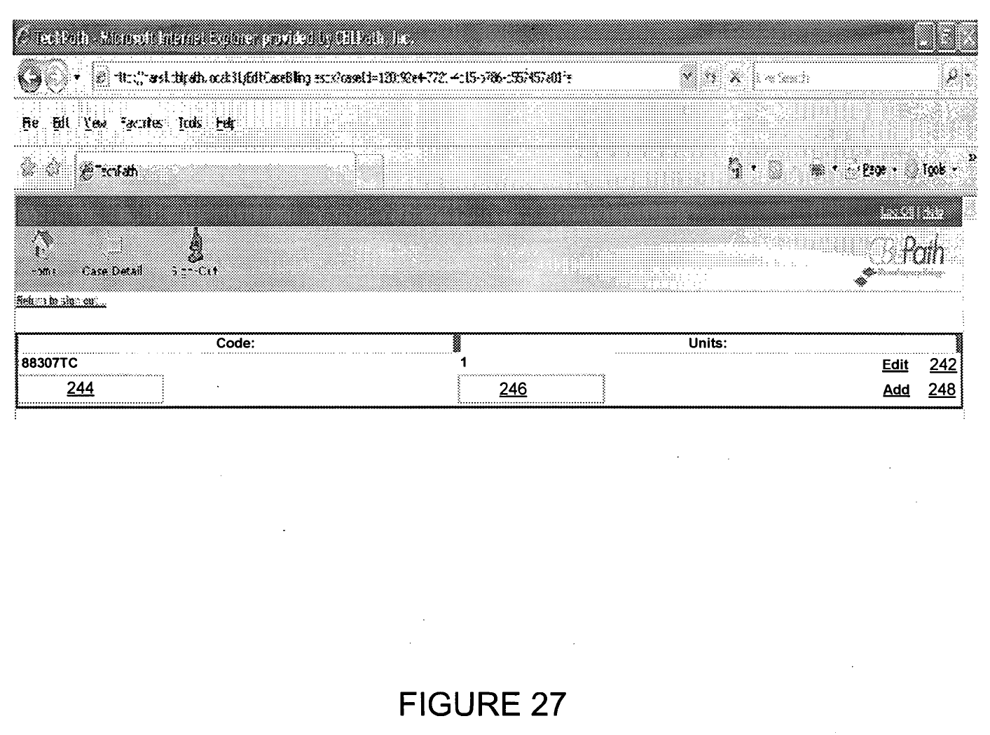

2. On the upper left corner of the Sign Out screen, the user clicks the pencil icon 240 next to the Billing Summary title bar. This will open the Billing Summary screen as seen in FIG. 27.

3. To edit a CPT code, the user clicks the Edit link 242 on the right side of the screen. This will allow the user to change the number of units of the CPT code associated with a case. In one embodiment, it is not possible to delete a CPT code from a case. If a CPT should not be billed for a case, the units should be set to zero.

4. To add a CPT to a case, the user types it in the text box 244 under the Code column and enters the number to be billed in the text box 246 in the Units column, then clicks the Add link 248.

The module may be used to edit ICD9 codes. The Edit ICD9 Selection link will only be available if a specimen has had ICD9s stacked.

1. Once a case is ready to be signed out, the user clicks the Sign Out icon at the top of the Case Detail. This will open the Sign Out screen.

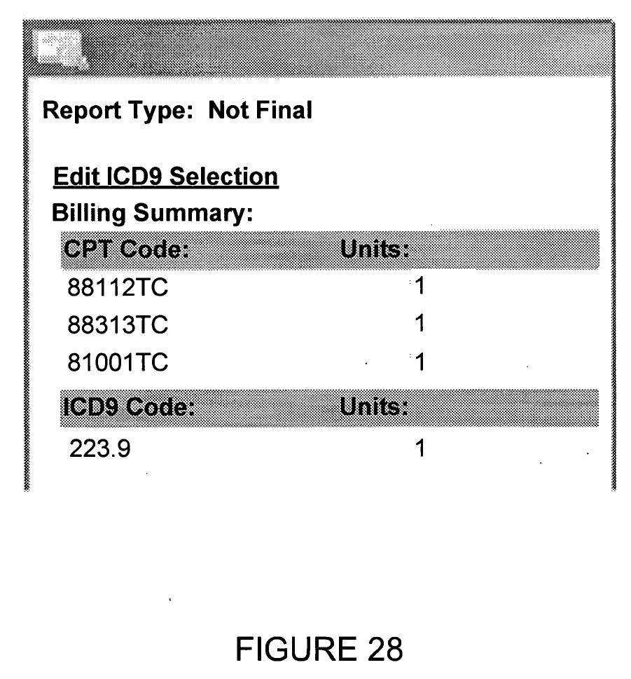

2. On the upper left corner of the Sign Out screen, the user clicks the Edit ICD9 Selection link 250. This will open the Edit ICD9 Selection screen as seen in FIG. 28.

3. On the Edit ICD9 Selection screen, all specimens with stacked ICD9s will be listed in the Specimens Pane at the top of the screen. To make a selection, the user clicks the link for one of the specimens in the Specimen pane. The currently selected specimen will be displayed in the Specimen Detail pane.

4. To select the correct ICD9 for the case, the user clicks the radio button to the left of the appropriate code then hits the Save button.

5. If there are multiple specimens with stacked ICD9s, the user may review each of them. Once done, the user clicks the Return to Sign Out link to return to the Sign Out screen.

Once all of the specimens have been diagnosed, the case can be signed out. To sign out a case, the user can take the following steps.

1. When all of the specimens have been diagnosed, the user returns to the Case Detail screen.

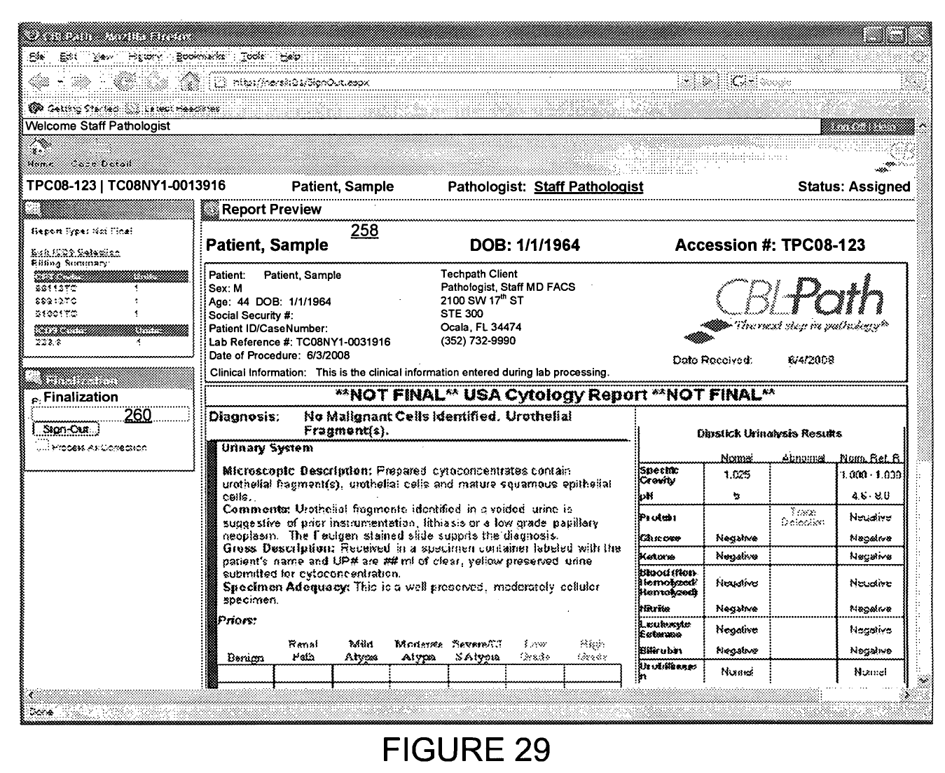

2. In the Case Detail screen, the user clicks the Sign Out icon at the top of the screen. This will open the Sign Out screen (FIG. 29).

3. The user reviews the report 258. If it requires revision, the user goes back to the Case Detail or the Specimen Detail to make any changes.

4. If there is a need to make any modifications to the billing information, that should be done prior to signing out the case.

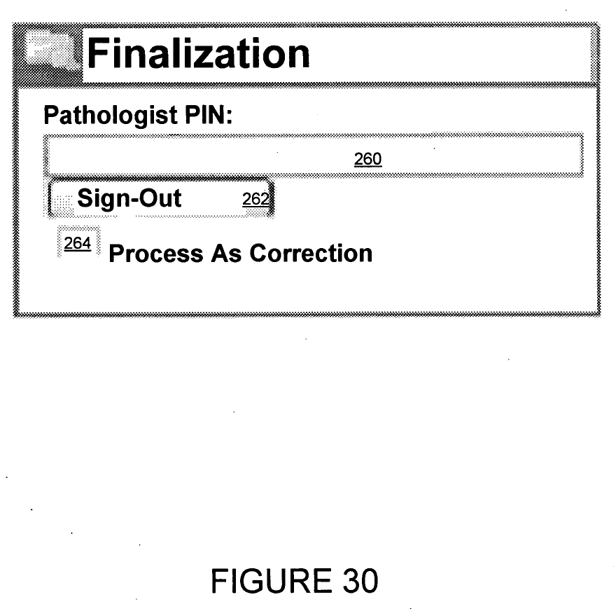

5. Once the user has reviewed the report, the user enters his or her PIN in the Pathologist's PIN text box 260 (FIG. 30) and hits the Sign Out button 262.

6. A confirmation screen will appear asking the user to confirm that he or she would like to sign out the case. Once the Yes button in the confirmation is hit, the case will be signed out and the report will be generated. In one embodiment, the report is generated within 30 minutes.

A case correction can occur up to 30 minutes (or some other pre-established time) from the moment the user confirms sign out of a case. Corrections allow the user to make changes to a report without having to issue an amendment. This is because the final report is not released to the client for 30 minutes (or whatever time is established for report generation) from the moment of sign out.

To issue a case correction, the user takes the following steps:

1. Within 30 minutes (or appropriate time period) of the initial sign out, the user opens the case, and makes and saves the required changes using the screens described above.

2. The user then navigates to the Sign Out screen.

3. In the PIN text box (FIG. 30), the user checks the Process as Correction check box 264, enters his or her PIN, and clicks the Sign Out button 262.

4. A confirmation screen will appear asking the user to confirm sign out of the case. Once the Yes button in the confirmation is hit, the case will be corrected and the new report will be generated in 30 minutes (or appropriate time period).

After a report has been generated, and case correction is no longer possible, modifications to a case must be made by “amending” the case. Amending a case is a three-part process, as described below.

First, the user opens the case to be amended, and makes the required changes. When the user saves the changes, the case status will be changed to Amended. Additionally, the user will now be able to add or log an amendment note.

An amendment note allows the user to indicate on the report the changes that have been made. To do this, the user takes the following steps:

1. The user navigates to the Case Detail of a case with the status of Amended.

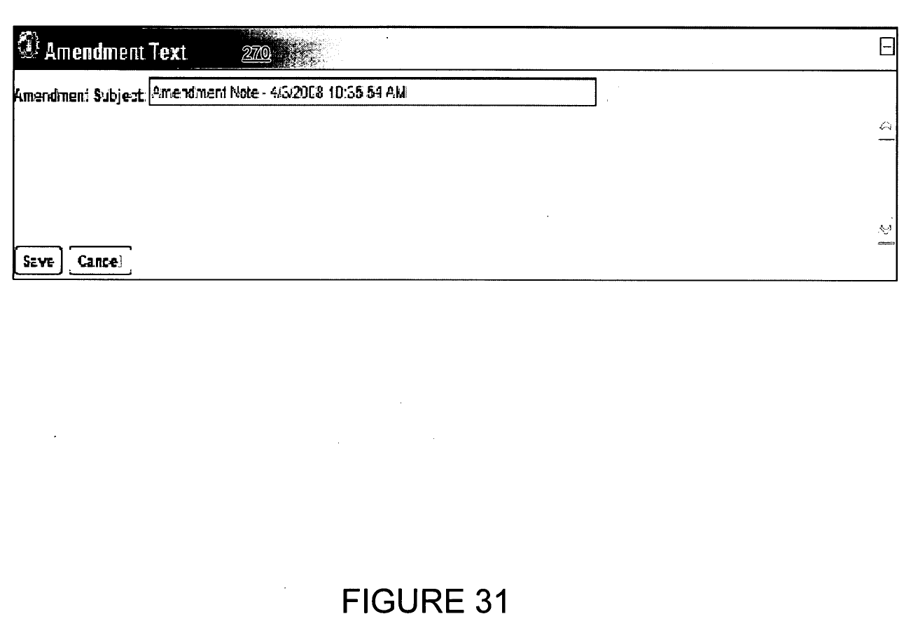

2. In the Amendment Text pane 270 (FIG. 31), the user enters or edits the amendment text accordingly.

3. The user then saves the amendment text.

Finally, the user must go through the sign out procedure again to finalize the amendment and issue the amended report. The user also has 30 minutes (or appropriate time period) after signing out the amendment to go back and issue a correction on the amendment, per the correction procedure described above.

A user also is able to add case comments, modify microscopic descriptions and change specimen notes in the form of an addendum. Changing other information, such as patient demographics, diagnostic text, or diagnostic classification, however, will trigger an amendment, as described above.

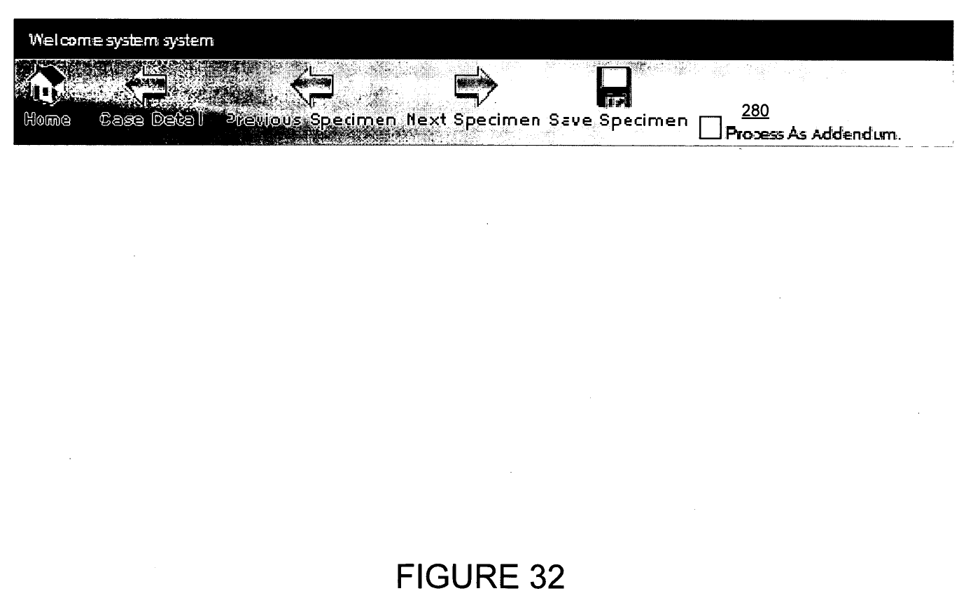

To addend a case, the user first opens the case to be addended. The Process as Addendum check box 280 at the top of the screen should be checked (see FIG. 32). The user then makes the required changes in the microscopic description, specimen notes, or case comments. Saving the changes then updates the case status to Addended.

The user can then log an Addendum note, which indicates on the report the changes that have been made. To log an addendum note, the user takes the following steps:

1. Navigate to the Case Detail of a case with the status of Addended.

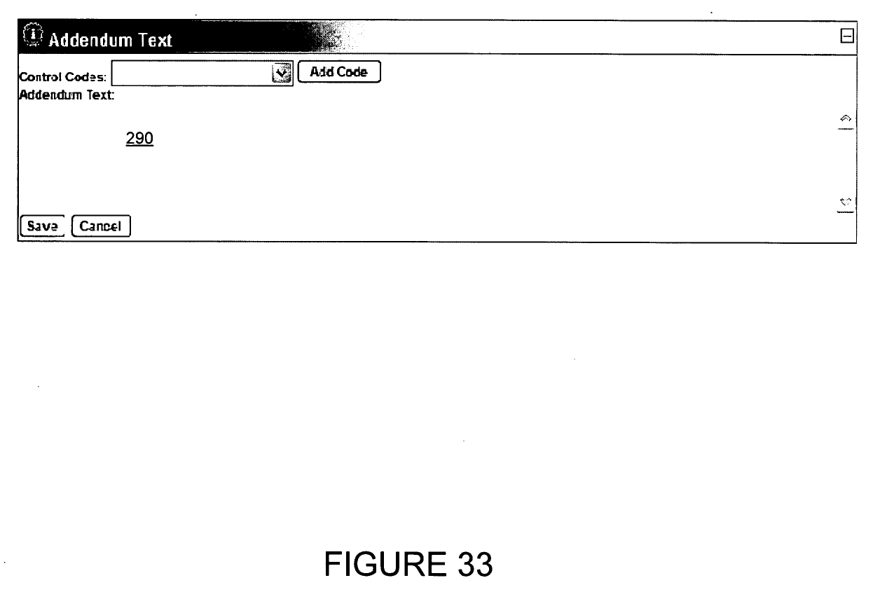

2. Use an Addendum control code or type the addendum text in the Addendum Text box 290 (FIG. 33) to indicate the updates to the report.

3. Save the addended text.

Finally, the user must go through the sign out procedure again to finalize the addendum and issue the addended report. The addendum may be corrected prior to the generation of the report, per the correction procedure described above.

Case reports can be produced in a variety of ways. For example, once a case has been signed out, a report can automatically be generated at the appropriate time period (e.g., 30 minutes) delivered via the system's delivery systems. Reports also can be printed out by direction selection. In one embodiment, the user may take the following steps.

1. After logging into TechPath (e.g., through a web browser), the user opens the case for which a report is desired.

2. From the Case Detail, the user clicks the More Information icon to navigate to the More Information screen.

3. The Documents data grid contains a list of all final documents associated with the case. Any document may be clicked on to be viewed. The user clicks on the most recent document to view the current report for the case. The report may then be printed, saved, or the like.

Control codes allow users to load saved text into specified fields by means of a simple code entry. This assures consistent and accurate input of information in the case diagnosis, case comments, case addendums and certain screens for special case types. Once a user has created a control code, it will appear in the Control Code combo box for the screen that corresponds to the code (e.g., the amendment control code will be available in the Amendment Control Code combo box).

Pathology Control Codes may be created by the following steps:

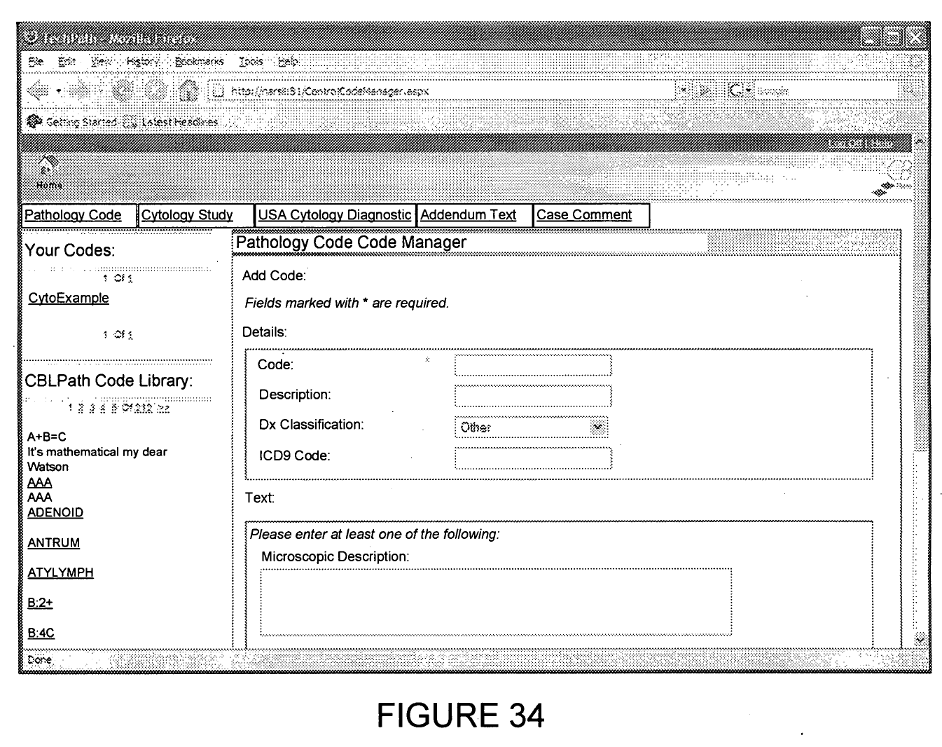

1. Once logged into TechPath, the user navigates to the Home Screen, and clicks the Control Codes icon at the top of the screen. This will open the Control Code Manager (FIG. 34).

2. In the Control Code Manager, the user will be automatically directed to the Pathology Control Code Manager.

3. On this screen, the user enters the following information:

| | |
|---|---|
| Code | This is the text the user will have to enter to load |
| | the code when diagnosing a case. |
| Description | Enter a description of the code for user reference. |
| DX | This is the classification of the diagnosis (e.g., |
| Classification | malignant, benign, etc.). |
| ICD9 Code | This is the ICD9 code that is associated with the |
| | diagnosis. |
| Microscopic | This is the text of the microscopic description that |
| Description | will load. |
| Diagnosis | This is the text of the diagnosis that will load. |
| Description | |
| Comments | This is the text of the specimen comment that will load. |
| Active Status | This indicates if the code is in active use. If this |
| Check Box | is unchecked, the control code is not accessible from |
| | the Specimen Detail. However, the code will remain |
| | accessible through the Control Code Manager. |

4. Once all of the applicable information has been entered, the user hits the Save button.

5. This will store the control code and the user will be able to use it in the Specimen Detail to diagnose specimens.

Cytology Study Control Codes may be created in a similar fashion:

1. Once logged into TechPath, the user navigates to the Home Screen, and clicks the Control Codes icon at the top of the screen. This will open the Control Code Manager (FIG. 34).

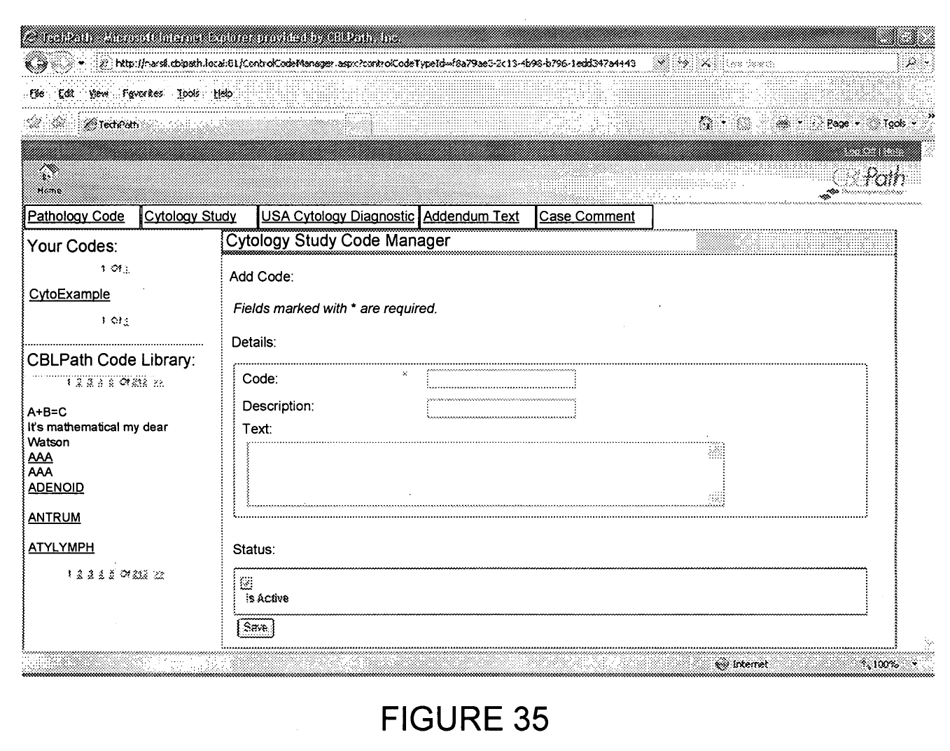

2. In the Control Code Manager, the user clicks the Cytology Study tab. This will open the Cytology Study Control Code Manager (FIG. 35).

3. On this screen, enter the following information:

| | |
|---|---|
| Code | This is the text the user will have to enter to load |
| | the code when diagnosing a case. |
| Description | Enter a description of the code for user reference. |
| Text | This is the text of the cytology study that will load |
| | when the control code is used in the Cytology Study |
| | screen. |
| | Note: The use of the caret symbol, \hat{ }, indicates insertion |
| | points for variable text. Thus anywhere the user enters |
| | a caret character within the text, it will be replaced |
| | by the text entered in the variable text box. |
| Active Status | This indicates if the code is in active use. If this is |
| Check Box | unchecked, the control code is not accessible from the |
| | Specimen Detail. However, the code will remain accessible |
| | through the Control Code Manager. |

4. Once all of the applicable information has been entered, the user hits the Save button.

5. This will store the control code and users will be able to use it in the Specimen Detail to enter cytology study information.

Urine Cytology Diagnostic Control Codes may be created in a similar fashion:

1. Once logged into TechPath, the user navigates to the Home Screen, and clicks the Control Codes icon at the top of the screen. This will open the Control Code Manager (FIG. 34).

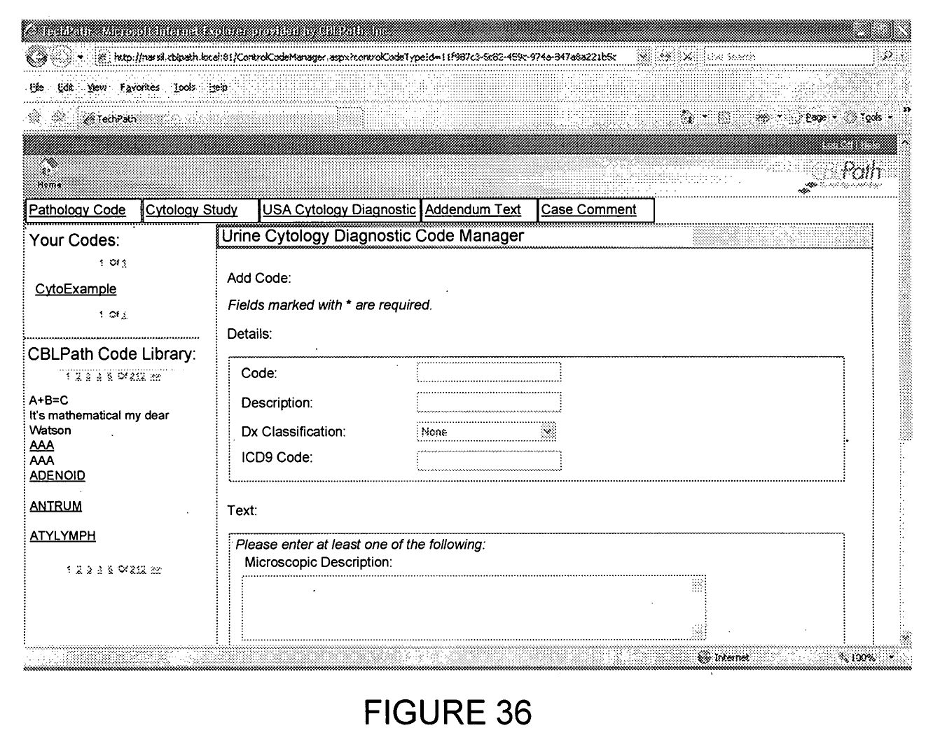

2. In the Control Code Manager, the user clicks the Urine Cytology Diagnostic tab. This will open the Urine Cytology Diagnostic Control Code Manager (FIG. 36).

3. On this screen, the user enters the following information:

| | |
|---|---|
| Code | This is the text the user will have to enter to load |
| | the code when diagnosing a case. |
| Description | Enter a description of the code for user reference. |
| DX | This is the classification of the diagnosis (e.g., |
| Classification | malignant, benign, etc.). |
| DX Sub- | This is the sub-classification of the diagnosis |
| Classification | (e.g., high-grade, low-grade, etc.). This information |
| | only appears on subsequent Urine Cytology cases for |
| | the same patient. |
| ICD9 Code | This is the ICD9 code that is associated with the |
| | diagnosis. |
| Microscopic | This is the text of the microscopic description that |
| Description | will load. |
| Diagnosis | This is the text of the diagnosis that will load. |
| Description | |
| Comments | This is the text of the specimen comment that will load. |
| Active Status | This indicates if the code is in active use. If this |
| Check Box | is unchecked, the control code is not accessible from |
| | the Specimen Detail. However the code will remain |
| | accessible through the Control Code Manager. |

4. Once all of the applicable information has been entered, the user hits the Save button.

5. This will store the control code and users will be able to use it in the Specimen Detail to diagnose Urine Cytology specimens.

Addendum Text Control Codes may be created in a similar fashion:

1. Once logged into TechPath, the user navigates to the Home Screen, and clicks the Control Codes icon at the top of the screen. This will open the Control Code Manager (FIG. 34).

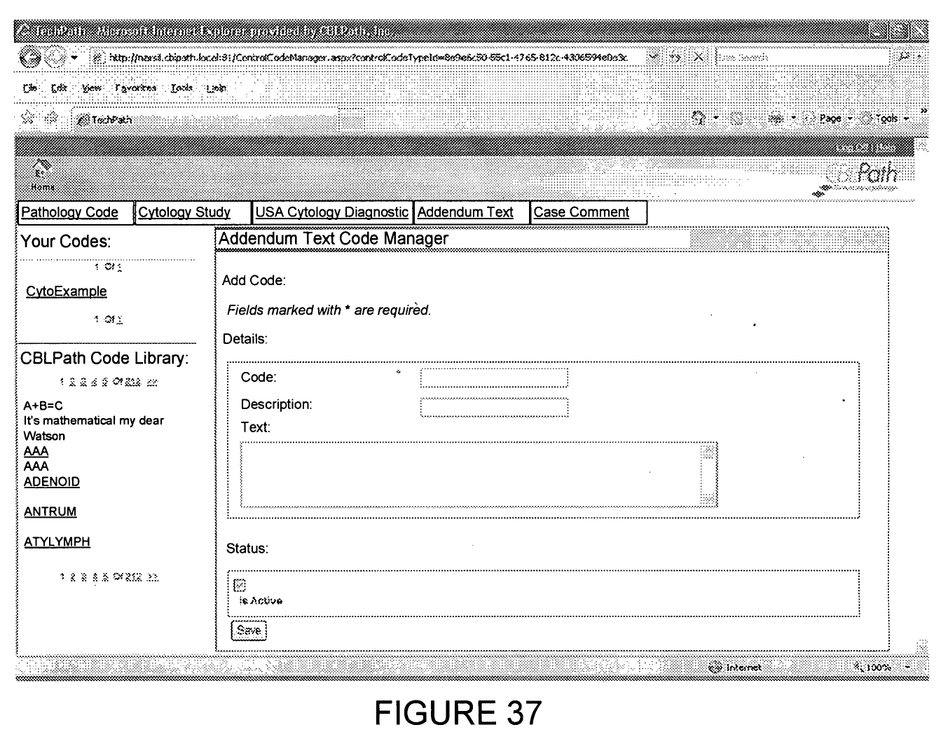

2. In the Control Code Manager, the user clicks the Addendum Text tab. This will open the Addendum Text Control Code Manager (FIG. 37).

3. On this screen, the user enters the following information:

| | |
|---|---|
| Code | This is the text the user will have to enter to load |
| | the code when diagnosing a case. |
| Description | Enter a description of the code for user reference. |
| Text | This is the text of the cytology study that will load |
| | when the control code is used in the Cytology Study |
| | screen. |
| Active Status | This indicates if the code is in active use. If this |
| Check Box | is unchecked, the control code is not accessible from |
| | the Specimen Detail. However, the code will remain |
| | accessible through the Control Code Manager. |

4. Once all of the applicable information has been entered, the user hits the Save button.

5. This will store the control code and users will be able to use it in the addendum text pane of the Case Detail screen.

Case Comments Control Codes may be created in a similar fashion:

1. Once logged into TechPath, the user navigates to the Home Screen, and clicks the Control Codes icon at the top of the screen. This will open the Control Code Manager (FIG. 34).

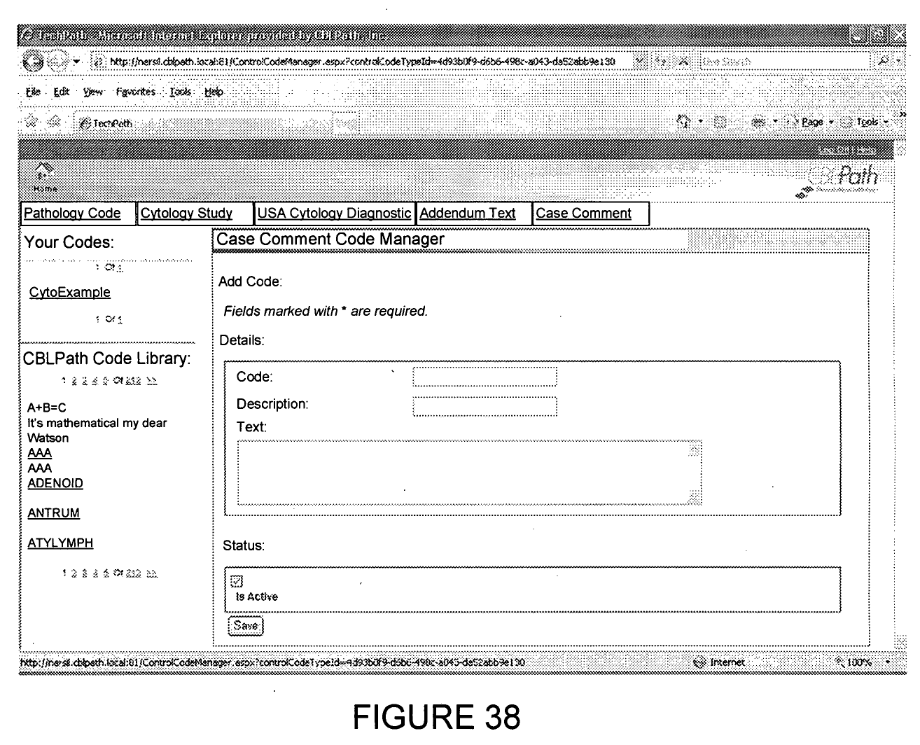

2. In the Control Code Manager, the user clicks the Case Comments tab. This will open the Case Comments Control Code Manager (FIG. 38).

3. On this screen, the user enters the following information:

| | |
|---|---|
| Code | This is the text the user will have to enter to load |
| | the code when diagnosing a case. |
| Description | Enter a description of the code for user reference. |
| Text | This is the text of the cytology study that will load |
| | when the control code is used in the Cytology Study |
| | screen. |
| Active Status | This indicates if the code is in active use. If this |
| Check Box | is unchecked, the control code is not accessible from |
| | the Specimen Detail. However the code will remain |
| | accessible through the Control Code Manager. |

4. Once all of the applicable information has been entered, the user hits the Save button.

5. This will store the control code and users will be able to use it in the case comments pane of the Case Detail screen.

A master library of control codes is available for use in case processing. In one exemplary embodiment, each master library control code must be saved to the user's own library to use it in case processing. To do this, the user takes the following steps.

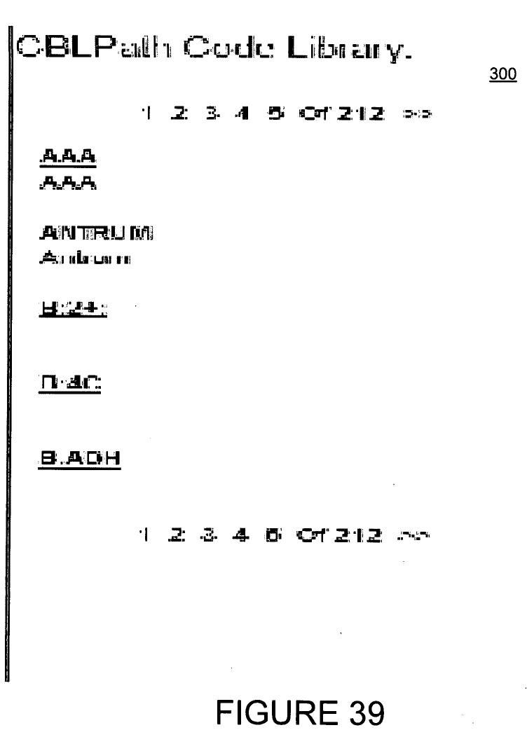

1. In the control code management screen (Pathology Code, Cytology Study, etc.) for which the user would like to save a master library code, the user clicks the blue code link in the Master Code Library pane 300 (FIG. 39).

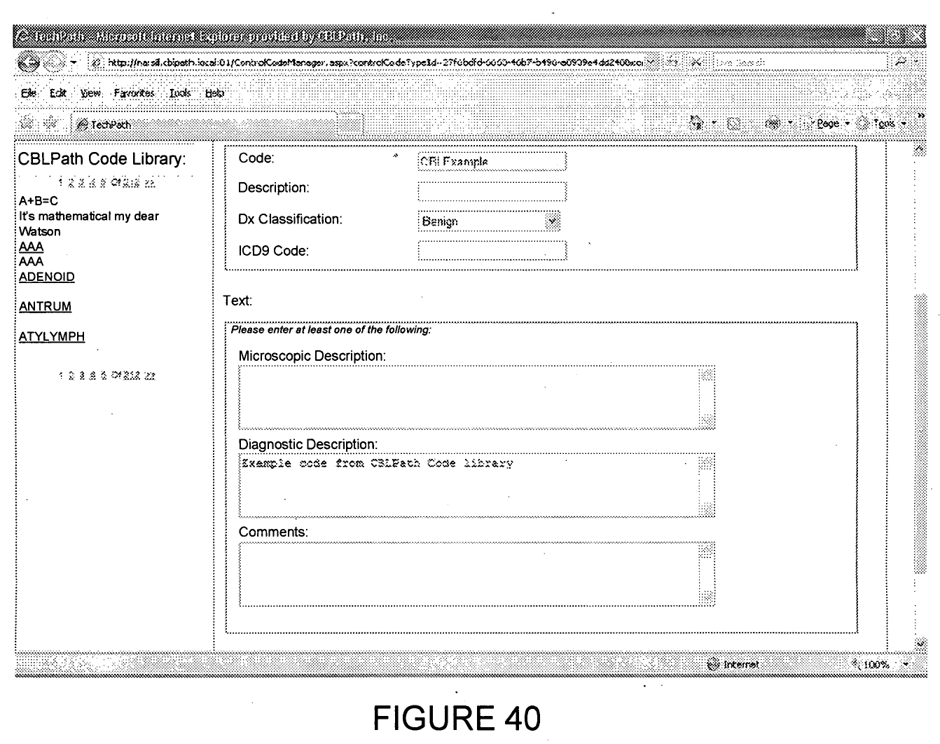

2. This will load the text of the control code to the Control Code Manager (FIG. 40).

3. The user makes any changes to the code text to suit his or her needs, and then hits the Save button. The code will be saved to the user library in its modified form and will be accessible for the user's future use. The code in the master library will not be changed.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. A method for processing pathology specimens, comprising the steps of:
receiving a specimen;
entering source data about the specimen into a database connected to a computer;
preparing the specimen for analysis;
entering data about the physical properties of the specimen into the database;
preparing one or more slides from the specimen; and
distributing said slides to one or more pathologists or other medical professionals for analysis.

2. The method of claim 1, wherein the step of entering data about the specimen is performed at least in part by using a bar-code scanner.

3. The method of claim 1, wherein the step of preparing slides is performed in response to processing instructions provided through a computing device.

4. The method of claim 1, further comprising the steps of:
analyzing the specimen; and
entering a diagnosis for the specimen into the database.

5. The method of claim 4, wherein the specimen is identified by use of a bar-code scanner.

6. The method of claim 4, further comprising the step of:
generating one or more reports concerning the specimen.

7. The method of claim 1, further wherein a management application monitors the progress of the specimen from the time of its receipt.

8. The method of claim 6, further wherein a billing application provides for the generation of bills.

9. A system for managing pathology services, comprising:
a management application accessed through an Internet web browser;
a database for storing information about a plurality of specimens, said database connected to a computer;
whereby a user can view information about a specimen, enter diagnosis information about a specimen, and order special procedures for a specimen.

10. The system of claim 9, wherein a user can upload a graphic image of a specimen for storage in the database.

11. The system of claim 9, wherein the user can enter cytology information for cytology cases.

12. The system of claim 9, further wherein a user can enter or edit billing information associated with a specimen.

13. The system of claim 9, further wherein a report is generated upon completion of processing of specimen data.
